(19) United States
(12) Patent Application Publication
(10) Pub. No.: US 2026/0133743 A1
(43) Pub. Date: May 14, 2026

(54) ELECTRONIC DEVICE AND METHOD OF OPERATING THE SAME

(71) Applicant: SAMSUNG ELECTRONICS CO., LTD., Suwon-si (KR)

(72) Inventors: Yonghyeok LEE, Suwon-si (KR); Hyungjong SHIN, Suwon-si (KR); Jungeun CHOI, Suwon-si (KR)

(73) Assignee: SAMSUNG ELECTRONICS CO., LTD., Suwon-si (KR)

(21) Appl. No.: 19/440,933

(22) Filed: Jan. 6, 2026

Related U.S. Application Data
(63) Continuation of application No. PCT/KR2025/014960, filed on Sep. 24, 2025.

(30) Foreign Application Priority Data
Sep. 24, 2024 (KR) 10-2024-0129431

(51) Int. Cl. G06F 3/14; G06F 3/04842; G06F 3/0488; G06F 9/451; H04N 7/15

(52) U.S. Cl. CPC G06F 3/1454; G06F 3/04842; G06F 9/452; H04N 7/15; G06F 3/0488

(57) ABSTRACT

An electronic device includes memory storing one or more instructions; and at least one processor wherein the one or more instructions, when executed by the at least one processor individually or collectively, cause the electronic device to display, on at least a part of a host operating system (OS) screen of a host OS, a guest OS screen corresponding to a guest application being executed on a guest OS, receive a screen sharing request through the guest application, and capture a screen of the host OS including the guest OS screen, and transmit the captured screen to a server for screen sharing based on the screen sharing request.

### CROSS-REFERENCE TO RELATED APPLICATIONS

This application is a continuation of International Application No. PCT/KR 2025/014960, filed on Sep. 24, 2025, which is based on and claims priority to Korean Patent Application No. 10-2024-0129431, filed on Sep. 24, 2024, in the Korean Intellectual Property Office, the disclosures of which are incorporated by reference herein in their entireties.

### BACKGROUND

### 1. Field

The disclosure relates to an electronic device and a method of operating the same, and more particularly, to an electronic device including a host system and a guest system and a method of operating the electronic device.

### 2. Description of Related Art

Electronic devices equipped with different types of operating systems (OSs) have been developed and released. Most electronic devices are executed on a single OS, but some electronic devices equipped with a plurality of OSs are released to gain technical or business advantages. For example, Samsung Smart TVs/Monitors are based on a Tizen OS, but Android on Tizen (AoT) platforms, on which a Tizen OS and an Android OS coexist, have been developed to execute Android applications.

With the development of wired/wireless communication networks and communication technology, the use of video conferencing services between electronic devices has increased. In detail, video conferencing services between electronic devices are widely used for non-face-to-face communication between different users in remote locations.

In detail, for a video call service, one electronic device and another electronic device may be connected to each other through a wired/wireless communication network. Here, the electronic device may be any electronic device that includes a display to provide a video conference screen and may perform communication with other electronic devices in remote locations by connecting to a wired/wireless communication network. Examples of the electronic device may include a portable computer such as a laptop computer, a netbook, or a tablet personal computer (PC), a portable terminal such as a smartphone or a personal digital assistant (PDA), a television (TV), and a digital TV.

When a video conference is performed between a plurality of electronic devices, for example, a first electronic device and a second electronic device, the first electronic device obtains an image of a first user and transmits the obtained image to the second electronic device. Also, the second electronic device obtains an image of a second user and transmits the obtained image to the first electronic device. Accordingly, each of the first electronic device and the second electronic device displays a video conference screen including the images of the first user and the second user. Then, each of the first user and the second user may have a conversation while watching the image of the other person at a remote location.

During this video conference, the first user may use a function of sharing a screen displayed on the first electronic device with conference participants. However, when the first electronic device is an electronic device equipped with different types of OSs including a host OS and a guest OS and a video conferencing application is executed based on the guest OS, an operation of sharing the screen of the first electronic device may not be smooth.

### SUMMARY

Provided are an electronic device and a method of operating the same, which enable an electronic device including a host system and a guest system to share a host screen in response to a screen sharing request from a guest application.

According to an aspect of the disclosure, an electronic device includes memory storing one or more instructions; and at least one processor wherein the one or more instructions, when executed by the at least one processor individually or collectively, cause the electronic device to display, on at least a part of a host operating system (OS) screen of a host OS, a guest OS screen corresponding to a guest application being executed on a guest OS; receive a screen sharing request through the guest application; and capture a screen of the host OS including the guest OS screen, and transmit the captured screen to a server for screen sharing based on the screen sharing request.

The one or more instructions, when executed by the at least one processor individually or collectively, may cause the electronic device to transmit the screen sharing request to the host OS via the guest OS; based on the screen sharing request being received by the host OS, capture, by the host OS, the screen of the host OS including the guest OS screen, and transmit the captured screen to the guest OS; and transmit the captured screen to the server via the guest application.

The one or more instructions, when executed by the at least one processor individually or collectively, may cause the electronic device to transmit to the host OS, by the guest OS, the screen sharing request and server identification information for the server; and based on the screen sharing request being received by the host OS, transmit the captured screen to the server, via the host OS, using the server identification information.

The one or more instructions, when executed by the at least one processor individually or collectively, may cause the electronic device to, based on the guest application being executed, designate a window of the host OS for the guest application, and display the guest OS screen on the designated window.

The guest application may be executed via an external device, and the one or more instructions, when executed by the at least one processor individually or collectively, may cause the electronic device to receive the guest OS screen through screen mirroring.

The one or more instructions, when executed by the at least one processor individually or collectively, may cause the electronic device to transmit the captured screen to the server based on the guest OS screen being received through the screen mirroring.

The one or more instructions, when executed by the at least one processor individually or collectively, may cause the electronic device to receive a screen sharing input through the guest OS; transmit the screen sharing input to the external device; receive the screen sharing request from the external device through the guest application; and based on the screen sharing request being received by the host OS, capture and output the screen of the host OS including the guest OS screen.

The one or more instructions, when executed by the at least one processor individually or collectively, may cause the electronic device to transmit the captured screen to the server via the external device; or directly transmit the captured screen from the host OS to the server using server identification information for the server.

The host OS and the guest OS may be configured to communicate through at least one of a virtual network interface or by forwarding a port from the host OS to the guest OS.

The server identification information may include a Uniform Resource Identifier (URI) of the server.

According to an aspect of the disclosure, a method of operating an electronic device includes displaying, on at least a part of a host operating system (OS) screen of a host OS, a guest OS screen corresponding to a guest application being executed on a guest OS; receiving a screen sharing request through the guest application; and capturing a screen of the host OS including the guest OS screen, and transmitting the captured screen to a server for screen sharing based on the screen sharing request.

The capturing the screen of the host OS and transmitting the captured screen may include transmitting the screen sharing request to the host OS via the guest OS; based on the screen sharing request being received by the host OS, capturing, by the host OS, the screen of the host OS including the guest OS screen, and transmitting the captured screen to the guest OS; and transmitting the captured screen to the server via the guest application.

The capturing the screen of the host OS and transmitting the captured screen may include transmitting to the host OS, by the guest OS, the screen sharing request and server identification information for the server; and based on the screen sharing request being received by the host OS, transmitting the captured screen to the server, via the host OS, using the server identification information.

The displaying the guest OS screen may include, based on the guest application being executed, designating a window of the host OS for the guest application, and displaying the guest OS screen on the designated window.

The guest application may be executed via an external device, and the receiving the guest OS screen may include receiving the guest OS screen through screen mirroring.

The transmitting the captured screen to the server may include transmitting the captured screen to the server based on the guest OS screen being received through the screen mirroring.

The method may further include receiving a screen sharing input through the guest OS; and transmitting the screen sharing input to the external device. The receiving the screen sharing request may include receiving the screen sharing request from the external device through the guest application, and the capturing the screen of the host OS may include, based on the screen sharing request being received by the host OS, capturing and outputting the screen of the host OS including the guest OS screen.

The transmitting the captured screen to the server may include transmitting the captured screen to the server via the external device; or directly transmitting the captured screen from the host OS to the server by using server identification information for the server.

The host OS and the guest OS may communicate through at least one of a virtual network interface or by forwarding a port from the host OS to the guest OS.

According to an aspect of the disclosure, a non-transitory computer-readable recording medium storing one or more instructions, wherein the one or more instructions, when executed by at least one processor of an electronic device, individually or collectively, cause the electronic device to display, on at least a part of a host operating system (OS) screen of a host OS, a guest OS screen corresponding to a guest application being executed on a guest OS; receive a screen sharing request through the guest application; and capture a screen of the host OS including the guest OS screen, and transmit the captured screen to a server for screen sharing based on the screen sharing request.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a reference diagram for describing an environment in which embodiments of the disclosure operate;

FIG. 2 illustrates an example of a system including an electronic device, a server, and a counterpart electronic device, according to an embodiment of the disclosure;

FIG. 3 illustrates an example of an electronic device including a host system and a guest system, according to an embodiment of the disclosure;

FIG. 4 illustrates an example of a host system and a guest system, according to an embodiment of the disclosure;

FIG. 5 illustrates an example of a flowchart illustrating a method of operating an electronic device, according to an embodiment of the disclosure;

FIG. 6 is a flowchart illustrating a method of executing a guest operating system (OS)-based application in an electronic device including a guest operating system OS and a host OS, according to an embodiment of the disclosure;

FIG. 7 illustrates an example of a guest OS screen and a host OS screen, according to an embodiment of the disclosure;

FIG. 8 illustrates an example of a screen on which a video conferencing application is executed as a guest application of a guest system of an electronic device, according to an embodiment of the disclosure;

FIG. 9 is a reference diagram for describing an operation of processing a screen sharing request received by a guest application of a guest system of an electronic device, according to an embodiment of the disclosure;

FIG. 10 is an example of a flowchart illustrating an operation of processing a screen sharing request received by a guest application of a guest system of an electronic device, according to an embodiment of the disclosure;

FIG. 11 is a reference diagram for describing an operation of processing a screen sharing request received by a guest application of a guest system of an electronic device, according to an embodiment of the disclosure;

FIG. 12 is an example of a flowchart illustrating an operation of processing a screen sharing request received by a guest application of a guest system of an electronic device, according to an embodiment of the disclosure;

FIG. 13 is a reference diagram for describing an operation in which an electronic device receives and displays a guest OS screen from an external device by using screen mirroring, according to an embodiment of the disclosure;

FIG. 14 is a reference diagram for describing an operation when a screen sharing menu is selected on a guest OS screen displayed by using screen mirroring in an electronic device, according to an embodiment of the disclosure;

FIG. 15 is an example of a flowchart illustrating an operation when a screen sharing menu is selected on a guest OS screen displayed by using screen mirroring in an electronic device, according to an embodiment of the disclosure;

FIG. 16 is a reference diagram for describing an operation when a screen sharing menu is selected in an external device while the external device provides a guest OS screen to an electronic device by using screen mirroring, according to an embodiment of the disclosure;

FIG. 17 is an example of a flowchart illustrating an operation when a screen sharing menu is selected on a guest OS screen displayed by using screen mirroring in an electronic device, according to an embodiment of the disclosure; and

FIG. 18 is an example of a detailed block diagram illustrating an electronic device, according to an embodiment of the disclosure.

### DETAILED DESCRIPTION

The terms used herein will be briefly described, and the disclosure will be described in detail.

The terms used herein are general terms currently widely used in the art in consideration of functions in the disclosure, but the terms may vary according to the intention of one of ordinary skill in the art, precedents, or new technology in the art. Also, some terms may be arbitrarily selected by the applicant, and in this case, the meaning of the selected terms will be described in detail in the detailed description of the disclosure. Accordingly, the specific terms used herein should be defined based on the unique meanings thereof and the whole context of the disclosure.

It will be understood that when a certain part “includes” a certain component, the part does not exclude another component but may further include another component, unless the context clearly dictates otherwise. Also, the term “. . . unit” or “. . . module” refers to a unit that performs at least one function or operation, and the unit may be implemented as hardware or software or as a combination of hardware and software.

Throughout the disclosure, the expression “at least one of a, b, or c” indicates only a, only b, only c, both a and b, both a and c, both b and c, all of a, b, and c.

Embodiments of the disclosure will now be described more fully with reference to the accompanying drawings for one of ordinary skill in the art to be able to perform the embodiments of the disclosure without any difficulty. However, the disclosure may be implemented in various different forms and is not limited to the embodiments described herein. For clarity, like components are denoted by like reference numerals throughout the specification.

The term “user” in an embodiment of the disclosure refers to a person who controls a function or operation of a computing device or an electronic device by using a control device, and may include a viewer, a manager, or an installation engineer.

Computers include general-purpose central processing units (CPUs) or processors designed to execute a specific set of system instructions. Each processor executes instructions that are unique to the processor. A set of instructions that may be executed by a processor is called an instruction set of the processor. The uniqueness of processors between computer systems typically results in incompatibility among the other elements of hardware architecture of the computer systems. Computer manufacturers want to maximize their market share by having more rather than fewer applications run on the microprocessor family associated with the computer manufacturers'product line. To increase the number of operating systems and application programs that may be executed on a computer system, a host computer having one type of CPU, called a host, may employ virtual machine technology that allows the host computer to emulate instructions for another type of CPU, called a guest.

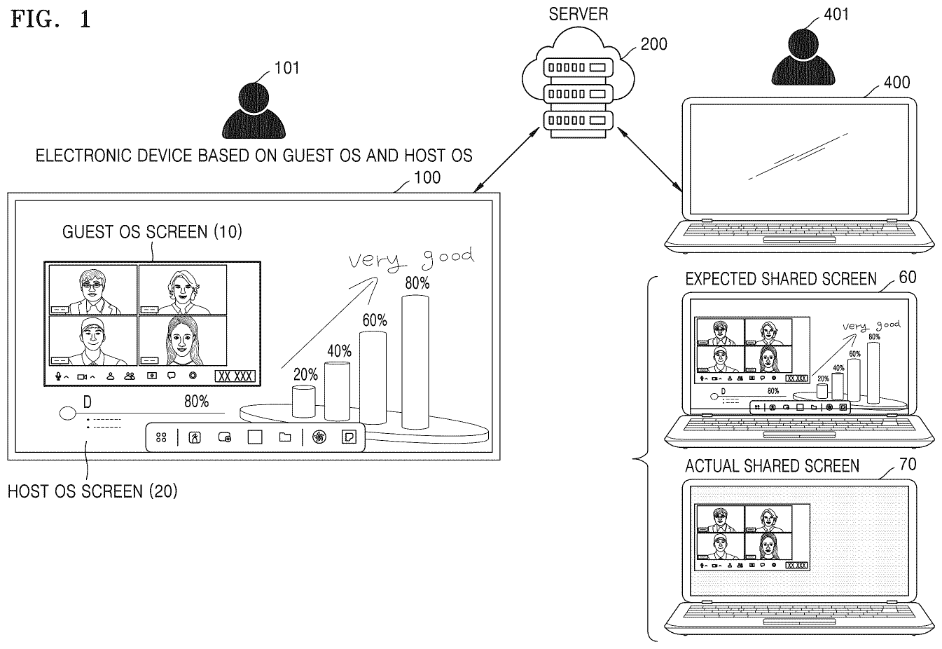

FIG. 1 is a reference diagram for describing an environment in which embodiments of the disclosure operate.

Referring to FIG. 1, the environment may include an electronic device 100, a server 200, and a counterpart electronic device 400.

Two display apparatuses, that is, the electronic device 100 and the counterpart electronic device 400, may provide a video conferencing service by using a video conferencing application. The term ‘application’ may refer to a program or a processor for performing a service, a function, or a specific operation. In detail, an application may include at least one instruction for performing a service, a function, or a specific operation. In an embodiment of the disclosure, an application for performing video conferencing services, functions, or operations may be referred to as a video conferencing application.

In an embodiment of the disclosure, a video conference refers to a conference in which a plurality of users in remote locations have conversations by using voices and/or videos through a plurality of electronic devices. Also, a ‘video conference’ described in an embodiment of the disclosure may be applied to any field in which users in remote locations communicate while receiving voices and/or videos from each other, such as video calls, non-face-to-face communication, or non-face-to-face education, and may refer to any case where a plurality of users in remote locations communicate while listening to voices of counterparts. An image included in a video conference screen does not need to be the face of a user using a video conference, and may be an image representing an environment where the user using the video conference is located or an image provided by the user. A video conference may be performed between two or more different electronic devices by two or more different users in remote locations.

Referring to FIG. 1, a video conference may be performed between electronic devices in remote locations, that is, between the electronic device 100 of a user 101 and the counterpart electronic device 400 of a counterpart user 401. Also, a video conference may be performed by transmitting and receiving data required for a video conference by using a communication network such as third generation (3G), fourth generation (4G), or fifth generation (5G). A video conference may be performed through a call service of a telecommunication company. Also, a video conference may be performed through a certain application (e.g., a video call application, a non-face-to-face communication application, a video education application, or a video conferencing application) provided through a server of a service provider.

In the following, including FIG. 1, an electronic device of a user is referred to as the electronic device 100, and an electronic device of a counterpart user who wants to have a video conference with the user is referred to as the counterpart electronic device 400. An electronic device of a user may be simply referred to as a first display apparatus, and an electronic device of a counterpart user may be referred to as a second display apparatus. Also, a user of the electronic device 100 will be referred to as a user, and a counterpart who wants to have a video conference with the user will be referred to as a counterpart user. Also, a user and a counterpart may be referred to as a first user and a second user, respectively. Also, although display apparatuses are described as an electronic device of a user and an electronic device of a counterpart in FIG. 1, various electronic devices such as smartphones may be used.

Referring to FIG. 1, the electronic device 100 may perform a video call with the counterpart electronic device 400, which is an electronic device of a counterpart in a remote location. The electronic device 100 may perform a video conference by performing its own call function or application for non-face-to-face communication. When the video conference starts, the electronic device 100 and the counterpart electronic device 400 performing the video conference may display a video conference screen. For example, the electronic device 100 of the user may display a video conference screen including an image of the user or the image of the counterpart user. Also, the video conference screen may further include menus for controlling the video conference. The menus for controlling the video conference may include, for example, a screen sharing function. The screen sharing function may refer to a function that allows one user to share his/her screen by transmitting the screen to other participants participating in the video conference. For example, the screen sharing function may be used when one of participants participating in the video conference wants to explain or have a have a conversation based on a document file opened on his/her electronic device while allowing other participants to view the document file together.

The electronic device 100 may include different types of operating systems (OSs), that is, a host OS and a guest OS. One or more applications based on the host OS may be executed according to the host OS, and one or more applications based on the guest OS may be executed according to the guest OS. For example, a device based on a Tizen system of Samsung Electronics may include a Tizen OS as a host OS and an Android OS as a guest OS. The device based on the Tizen system may execute a Tizen OS-based application by using the Tizen OS, and may execute an Android OS-based application by using the Android OS.

A video conferencing application executed by the user of the electronic device 10 for a video conference with other participants may be an application executed based on the guest OS. Referring to FIG. 1, the electronic device 100 may display a video conferencing application screen by executing a video conferencing application based on the guest OS. Hereinafter, an application screen based on the guest OS will be referred to as a guest OS screen 10. The electronic device 100 may display the guest OS screen 10 on at least a part of a screen displayed by executing an application based on the host OS. Hereinafter, an application screen based on the host OS will be referred to as a host OS screen 20.

As such, when the user selects the screen sharing function in a state where the guest OS screen 10 is displayed in the electronic device 100, the user may expect a full screen state displayed on a display of the electronic device 100, that is, expect to screen share the host OS screen 20 including the guest OS screen 10, as shown in an expected shared screen 60 of FIG. 1. However, because the video conferencing application triggered by the screen sharing function is based on the guest OS, it only recognizes a window based on the guest OS, that is, the guest OS screen 10, and does not recognize the host OS screen 20 is not known. Accordingly, when the user selects the screen sharing function in this situation, the electronic device 100 may transmit only the guest OS screen 10 to the server 200 for screen sharing, and thus, an actual shared screen 70 as shown in FIG. 1 may be shared. Accordingly, it may be difficult for the electronic device 100 to screen share a full screen representing the host OS screen 20 including the guest OS screen 10.

Considering this situation, embodiments of the disclosure propose an electronic device and a method of operating the same, which may provide a full host OS screen even when a screen sharing operation is performed by an application executed on a guest OS.

According to an embodiment of the disclosure, an electronic device may display, on at least a part of a OS screen of a host OS, a guest OS screen corresponding to a guest application being executed on the guest OS; receive a screen sharing request through the guest application; and capture a screen of the host OS including the guest OS screen, and transmit the captured screen to a server for screen sharing based on the screen sharing request.

According to an embodiment of the disclosure, the electronic device may transmit the screen sharing request to the host OS via the guest OS; based on the screen sharing request being received by the host OS, capture, by the host OS, the screen of the host OS including the guest OS screen, and transmit the captured screen to the guest OS; and transmit the captured screen to the server via the guest application.

According to an embodiment of the disclosure, the electronic device may transmit to the host OS, by the guest OS, the screen sharing request and server identification information for the server.

According to an embodiment of the disclosure, the electronic device may, based on the screen sharing request being received by the host OS, transmit the captured screen to the server, via the host OS, using the server identification information.

According to an embodiment of the disclosure, the electronic device may, based on the guest application being executed, designate, a window of the host OS for the guest application, and display the guest OS screen on the designated window.

According to an embodiment of the disclosure, the guest application may be executed via an external device, and the electronic device may receive the guest OS screen through screen mirroring.

According to an embodiment of the disclosure, the electronic device may transmit the captured screen to the server based on the guest OS screen being received through the screen mirroring.

According to an embodiment of the disclosure, the electronic device may receive a screen sharing input through the guest OS; transmit the screen sharing input to the external device; receive the screen sharing request from the external device through the guest application; and based on the screen sharing request being received by the host OS, capture and output the screen of the host OS including the guest OS screen.

According to an embodiment of the disclosure, the electronic device may transmit the captured screen to the server via the external device; or directly transmit the captured screen from the host OS to the server using server identification information for the server.

According to an embodiment of the disclosure, the host OS and the guest OS may be configured to communicate through at least one of a virtual network interface or by forwarding a port from the host OS to the guest OS.

According to an embodiment of the disclosure, the server identification information may include a Uniform Resource Identifier (URI) of the server.

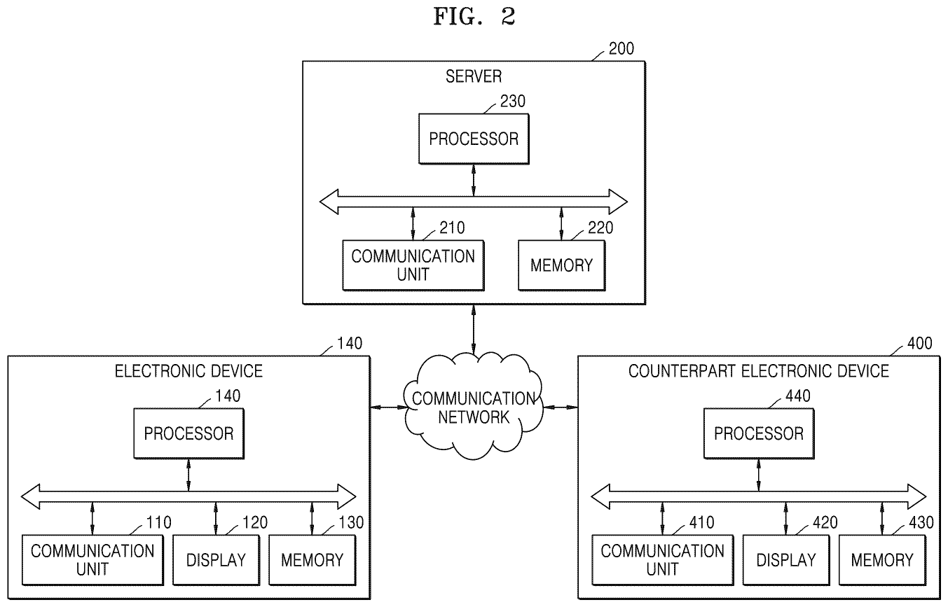

FIG. 2 illustrates an example of a system including an electronic device, a server, and a counterpart electronic device, according to an embodiment of the disclosure.

Referring to FIG. 2, the electronic device 100, the server 200, and the counterpart electronic device 400 may be connected to a communication network, and the electronic device 100 and the counterpart electronic device 400 may communicate with each other through the server 200.

The electronic device 100 is a device capable of displaying an image or data, and may include a communication unit (or communication interface) 110, a display 120, a memory 130, and a processor 140.

The communication unit 110 may include various communication circuits for performing communication with at least one external device. The term ‘communication’ may refer to an operation of transmitting and/or receiving data, a signal, a request, and/or a command. The following will be described assuming that at least one external device is the server 200.

The communication unit 110 may perform wired or wireless communication with the external device.

For example, the communication unit 110 may include at least one of a communication module, a communication circuit, a communication device, an input/output port, or an input/output plug for performing wired communication with the external device.

For example, the communication unit 110 may include at least one wireless communication module, wireless communication circuit, or wireless communication device for performing wireless communication with the external device.

For example, the communication unit 110 may include a short-range communication module, for example, an infrared (IR) communication module, that may receive a control command from a remote controller located at a short distance, for example, an input device. In this case, the communication unit 110 may receive a control signal from the remote controller.

For example, the communication unit 110 may include at least one communication module for performing communication according to a wireless communication standard such as Bluetooth, Wi-Fi, Bluetooth low energy (BLE), NFC/RFID, Wi-Fi Direct, UWB, or ZIGBEE. The communication unit 110 may further include a communication module for performing communication with the server to support long-range communication according to a long-range communication standard. For example, the communication unit 110 may include a communication module for performing communication through a network for Internet communication. Also, the communication unit 110 may include a communication module for performing communication through a communication network according to a communication standard such as 3G, 4G, 5G, and/or 6G.

For example, in order to communicate by wire with the external device, the communication unit 110 may include at least one port for connection to the external device by a wire cable. For example, the communication unit 110 may include at least one of a high-definition multimedia interface (HDMI) port, a component jack, a PC port, a display port, or a universal serial bus (USB) port. Accordingly, the communication unit 110 may communicate with the electronic device 100 connected by wire through at least one port. The term ‘port’ may refer to a physical interface for connection or insertion of a cable, a communication line, or a plug.

As described above, the communication unit 110 may include at least one support element for supporting communication between the electronic device 100 and the external device. Examples of the support element may include a communication module, a communication circuit, a communication device, a port (for input/output of data), a cable port (for input/output of data), and a plug (for input/output of data) as described above. Examples of the at least one support element included in the communication unit 110 may include an Ethernet communication module, a Wi-Fi communication module, a Bluetooth communication module, an IR communication module, a USB port, a tuner (or a broadcast receiver), an HDMI port, a display port (DP), and a digital visual interface (DVI) port.

The display 120 may output an image or data processed by the electronic device 100.

The memory 130 may store a program for processing and control of the processor 140, and may store data input to the electronic device 100 or output from the electronic device 100. Also, the memory 130 may store data required for an operation of the electronic device 100.

The memory 130 may include at least one type of storage medium of a flash memory type storage unit, a hard disk type storage unit, a multimedia card micro type storage unit, a card type memory (e.g., an SD or XD memory), a random-access memory (RAM), a static random-access memory (SRAM), a read-only memory (ROM), an electrically erasable programmable read-only memory (EEPROM), a programmable read-only memory (PROM), a magnetic memory, a magnetic disk, or an optical disk.

The processor 140 controls an overall operation of the electronic device 100. For example, the processor 140 may perform a function of the electronic device 100, by executing one or more instructions stored in the memory 130.

The processor 140 may include various processing circuits and/or a plurality of processors. For example, the term “processor” used in the specification including the claims may include various processing circuits including at least one processor. In the at least one processor, one or more processors may be configured to perform various functions described herein, individually and/or collectively, in a distributed fashion. As used herein, the “processor”, “at least one processor”, and “one or more processors” may be configured to perform various functions. However, these terms cover, for example, without limitation, a situation where one processor performs some of functions and other processors perform others of the functions, and a situation where a single processor may perform all functions. Also, the at least one processor may include a combination of processors for performing various functions of disclosed functions in a distributed fashion. The at least one processor may execute program instructions to achieve or perform various functions.

In an embodiment of the disclosure, the processor 140 may control operations of the display apparatus to be performed by storing one or more instructions in an internal memory provided therein and executing the one or more instructions stored in the internal memory provided therein. That is, the processor 140 may perform a certain operation by executing at least one instruction or program stored in the internal memory provided in the processor 140 or in the memory 130.

According to an embodiment of the disclosure, the processor 140 may perform an operation of the electronic device 100, by executing one or more instructions stored in the memory 130.

According to an embodiment of the disclosure, the at least one processor 140, by executing one or more instructions stored in the memory 130, may display, according to execution of a guest application based on a guest OS, a guest OS screen corresponding to the guest application on at least a part of a host OS screen based on a host OS.

According to an embodiment of the disclosure, the at least one processor 140, by executing one or more instructions stored in the memory 130, may receive a screen sharing request through the guest application.

According to an embodiment of the disclosure, the at least one processor 140, by executing one or more instructions stored in the memory 130, may transmit, according to the screen sharing request, the host OS screen including the guest OS screen to a server for screen sharing.

According to an embodiment of the disclosure, the at least one processor 140, by executing one or more instructions stored in the memory 130, may transmit, according to the screen sharing request, by the guest OS, the screen sharing request to the host OS.

According to an embodiment of the disclosure, the at least one processor 140, by executing one or more instructions stored in the memory 130, may capture, by the host OS, according to the screen sharing request from the guest OS, the host OS screen including the guest OS screen, and may transmit the host OS screen including the guest OS screen to the guest OS.

According to an embodiment of the disclosure, the at least one processor 140, by executing one or more instructions stored in the memory 130, may transmit, by the guest application, the host OS screen including the guest OS screen to the server.

According to an embodiment of the disclosure, the at least one processor 140, by executing one or more instructions stored in the memory 130, may transmit, according to the screen sharing request, by the guest OS, the screen sharing request together with server identification information for identifying the server to the host OS.

According to an embodiment of the disclosure, the at least one processor 140, by executing one or more instructions stored in the memory 130, may transmit, by the host OS, according to the screen sharing request from the guest OS, the host OS screen including the guest OS screen to the server by using the server identification information.

According to an embodiment of the disclosure, the at least one processor 140, by executing one or more instructions stored in the memory 130, may designate, according to execution of the guest application, by the host OS, a window for the guest application, and may display the guest OS screen on the designated window.

According to an embodiment of the disclosure, the at least one processor 140, by executing one or more instructions stored in the memory 130, may receive and display the guest OS screen corresponding to the guest application executed in an external device through screen mirroring.

According to an embodiment of the disclosure, the at least one processor 140, by executing one or more instructions stored in the memory 130, may transmit, according to the screen sharing request through the guest OS screen displayed based on the screen mirroring in the electronic device, the host OS screen including the guest OS screen to the server.

According to an embodiment of the disclosure, the at least one processor 140, by executing one or more instructions stored in the memory 130, may receive a screen sharing input through the guest OS screen displayed based on the screen mirroring.

According to an embodiment of the disclosure, the at least one processor 140, by executing one or more instructions stored in the memory 130, may receive, according to transmission of the screen sharing input to the external device, a screen sharing request of the host OS screen from the external device.

According to an embodiment of the disclosure, the at least one processor 140, by executing one or more instructions stored in the memory 130, may capture and output, according to the screen sharing request of the host OS screen, the host OS screen including the guest OS screen.

According to an embodiment of the disclosure, the at least one processor 140, by executing one or more instructions stored in the memory 130, may transmit the host OS screen including the guest OS screen to the external device or may directly transmit the host OS screen including the guest OS screen to the server by using server identification information.

The electronic device 100 may be any type of device that includes a processor and a memory and performs a function. The electronic device 100 may be a fixed or portable device. For example, the electronic device 100 includes a display and may display image content, video content, game content, graphic content, etc. Examples of the electronic device 100 may include various electronic devices capable of receiving and outputting content such as a television such as a network TV, a smart TV, an Internet TV, a web TV, or an IPTV, a computer such as a desktop, a laptop, or a tablet, and any of various smart devices such as a smartphone, a cellular phone, a game player, a music player, a video player, medical equipment, or a home appliance.

A block diagram of the electronic device 100 of FIG. 2 is a block diagram for an embodiment of the disclosure. Each component of the block diagram may be integrated or added according to specifications of the electronic device 100 that is actually implemented. For example, when necessary, two or more components may be combined into one component, or one component may be sub-divided into two or more components. Also, a function performed in each block is intended to describe embodiments of the disclosure, and its detailed operation or device does not limit the scope of the disclosure.

The server 200 may include a communication unit 210, a memory 220, and a processor 230.

The communication unit 210 may include various communication circuits for performing communication with the electronic device 100 and the counterpart electronic device 400 through a communication network.

The memory 220 may store a program for processing and control of the processor 230, and may store data received by the server 200 or output from the server 200. Also, the memory 220 may store data required for an operation of the server 200.

The processor 230 controls an overall operation of the server 200. For example, the processor 230 may perform a function of the server 200, by executing one or more instructions stored in the memory 220.

According to an example, the server 200 may mediate a video conference operation between the electronic device 100 and the counterpart electronic device 400. For example, the server 200 may transmit images or voices of users participating in a video conference to the electronic device 100 and the counterpart electronic device 400, and may transmit images or voices of the users received from the electronic device 100 and the counterpart electronic device 400 to devices of other users participating in the voice conference for the video conference operation between the electronic device 100 and the counterpart electronic device 400.

The counterpart electronic device 400 is a device capable of displaying an image or data, and may include a communication unit 410, a display 420, a memory 430, and a processor 440.

The communication unit 410 may include various communication circuits for performing communication with the server 200 through a communication network.

The display 420 may output an image or data processed by the counterpart electronic device 400.

The memory 430 may store a program for processing and control of the processor 440, and may store data received by the counterpart electronic device 400 or data output from the counterpart electronic device 400. Also, the memory 430 may store data required for an operation of the counterpart electronic device 400.

The processor 440 controls an overall operation of the counterpart electronic device 400. For example, the processor 440 may perform a function of the counterpart electronic device 400, by executing one or more instructions stored in the memory 430.

According to an example, the counterpart electronic device 400 may perform a video conference operation through the server 200. For example, the counterpart electronic device 400 may transmit an image or a voice of the counterpart user of the counterpart electronic device 400 to the server 200 in order to transmit the image or the voice to other users participating in a video conference. Also, the counterpart electronic device 400 may receive images or voices of the other users participating in the video conference through the server 200.

Although one counterpart electronic device 400 participating in the video conference operation is illustrated in FIG. 2, it will be understood that when a plurality of users participate in a video conference operation, there may be two or more counterpart electronic devices 400.

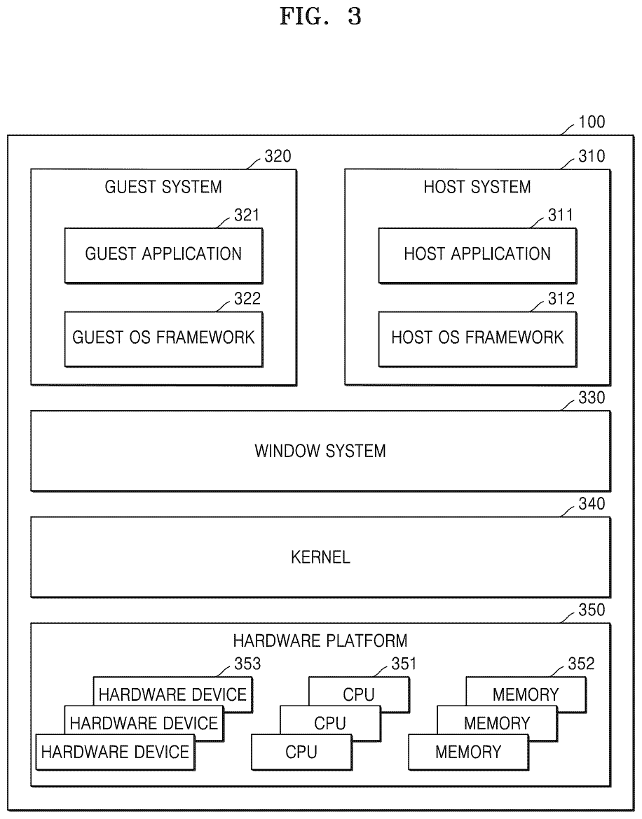

FIG. 3 illustrates an example of an electronic device including a host system and a guest system, according to an embodiment of the disclosure. The electronic device 100 of FIG. 3 has a structure in software and hardware aspects.

Referring to FIG. 3, the electronic device 100 may include a host system 310, a guest system 320, a window system 330, a kernel 340, and a hardware platform 350.

The electronic device 100 may be a computer supporting execution of an operating system and one or more application programs. The electronic device 100 may be a general-purpose computer or a display apparatus. Examples of the electronic device may include various electronic devices capable of receiving and outputting content, such as a network TV, a smart TV, an Internet TV, a web TV, an IPTV, and a PC.

The host system 310 provides an operating system platform for executing processes on the electronic device 100. The host system 310 controls all hardware devices in the electronic device 100 and manages system resources for all applications executed therein.

The host system 310 may include a host application 311 and a host OS framework 312.

The host application 311 may be an application that may be executed based on a host operating system. The host application 311 may include, for example, a home application initially executed when the electronic device 100 is booted.

The host OS framework 312 may include various different components such as a support program, a compiler, a code library, an API, and a class, which implement an application program standard structure for the host operating system.

The guest system 320 is a software component of a physical computing device and implements a computing platform that supports execution of software applications under the control of a guest operating system. Examples of the guest system may include well-known commercial operating systems such as Android® from Google, Window® from Microsoft, Linux® operating system, and MacOS® from Apple.

The guest system 320 may include a guest application 321 and a guest OS framework 322.

The guest application 321 may be one or more applications that may be executed based on the guest operating system. For example, the guest application 321 may include a video conferencing application.

The guest OS framework 322 may include various different components such as a support program, a compiler, a code library, an API, and a class, which implement an application program standard structure for the guest operating system.

The window system 330 is software that individually manages different portions of a display screen. The window system 330 is a type of graphical user interface implementing windows, icons, menus, and a pointer for user interface. Each application that is being currently executed is assigned a resizable quadrangular surface, that is, a window, in order to show a graphical user interface to a user. The windows may overlap each other.

The kernel 340 connects the host system 310, the guest system 320, and the physical hardware platform 350 of the electronic device 100. The kernel 340 is a central operating system component and is directly executed on the host. The kernel 340 is configured to allocate a memory, schedule access to a physical CPU, and schedule access to physical hardware devices connected to the electronic device 100.

The hardware platform 350 may include one or more physical CPUs 351, one or more memories 352, and one or more physical hardware devices 353. The memory may include a random-access memory in which programs that are currently being executed and data used in the programs are stored. The hardware platform may also include channels and an adaptor.

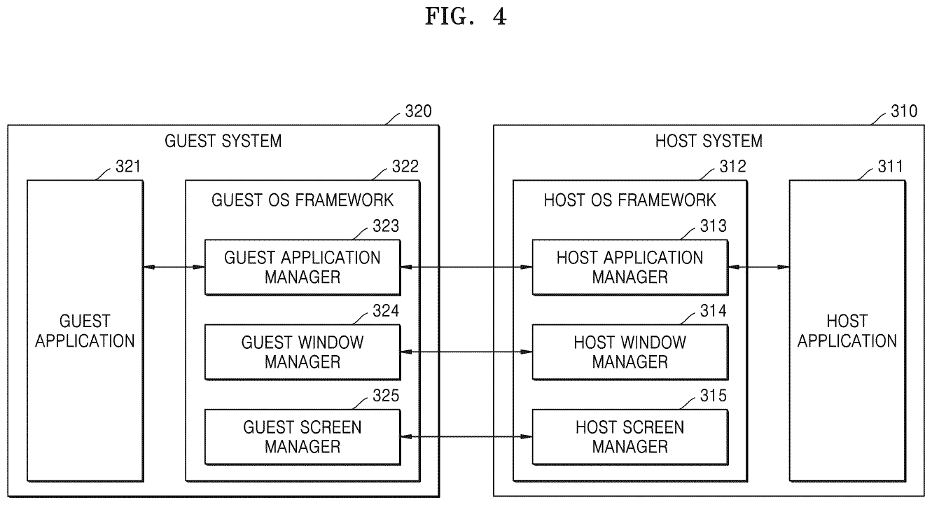

FIG. 4 illustrates an example of a host system and a guest system, according to an embodiment of the disclosure.

Referring to FIG. 4, the host system 310 may include the host application 311 and the host OS framework 312.

The host OS framework 312 may include a host application manager 313, a host window manager 314, and a host screen manager 315.

The host application manager 313 may manage a host application. For example, the host application manager 313 may manage the installation or removal and update of the host application, may manage access rights of the host application to a camera or a microphone, may monitor the performance or state of the host application, and may manage a data file generated by the host application.

The host window manager 314 may be responsible for managing the window arrangement, resizing, movement, and display of windows in a window system providing a graphical user interface, in the host system.

The host screen manager 315 may be responsible for various settings and management related to a screen in the host system.

The guest system 320 may include the guest application 321 and the guest OS framework 322.

The guest OS framework 322 may include a guest application manager 323, a guest window manager 324, and a guest screen manager 325.

The guest application manager 323 may be responsible for managing the guest application. For example, the guest application manager 323 may manage the installation or removal and update of the host application, may manage access rights of the host application to a camera or a microphone, may monitor the performance or state of the host application, and may manage a data file generated by the host application.

The guest window manager 324 may be responsible for managing the window arrangement, resizing, movement, and display of windows in the window system providing the graphical user interface, in the guest system.

The guest screen manager 325 may be responsible for various settings and management related to a screen in the guest system.

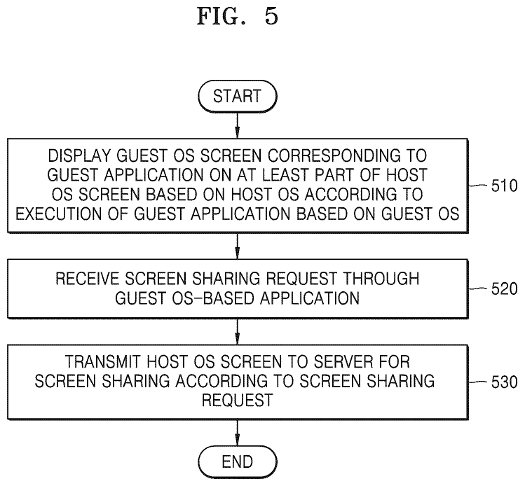

FIG. 5 illustrates an example of a flowchart illustrating a method of operating an electronic device, according to an embodiment of the disclosure.

Referring to FIG. 5, in operation 510, according to execution of a guest application based on a guest OS, the electronic device 100 may display a guest OS screen corresponding to a guest OS-based application on at least a part of a host OS screen based on a host OS.

The electronic device 100 may display the host OS screen by executing one or more host applications based on the host OS. Also, when one or more guest applications are executed based on the guest OS, the electronic device 100 may display a guest OS screen corresponding to the guest applications on the host OS screen.

In operation 520, the electronic device 100 may receive a screen sharing request through the guest application. For example, the electronic device 100 may receive a user input corresponding to the screen sharing request through the guest application. For example, the electronic device 100 may receive the screen sharing request according to a user input that selects a screen sharing menu provided on the guest OS screen corresponding to the guest application.

In operation 530, the electronic device 100 may transmit the host OS screen including the guest OS screen to a server for screen sharing according to the screen sharing request.

According to an embodiment of the disclosure, the electronic device 100 may transmit the screen sharing request from the guest OS to the host OS according to the screen sharing request of the guest application.

According to an embodiment of the disclosure, the electronic device may capture, by the host OS, the host OS screen and may transmit the captured host OS screen to the guest application through the guest OS.

According to an embodiment of the disclosure, the electronic device 100 may transmit, by the guest application, the host OS screen to the server.

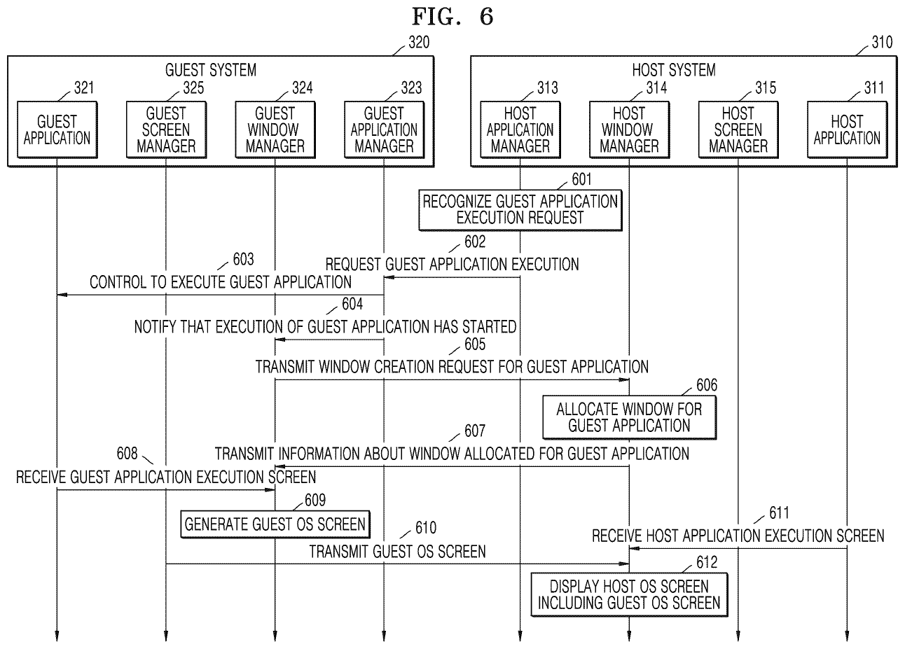

FIG. 6 is a flowchart illustrating a process of a method of executing a guest OS-based application in an electronic device including a guest OS and a host OS, according to an embodiment of the disclosure.

Referring to FIG. 6, in operation 601, when there is an application execution request in the electronic device 100 including a guest OS and a host OS, the host application manager 313 of the host system 310 may determine whether an application requested to be executed is based on the host OS or the guest OS and may recognize that the application requested to be executed is based on the guest OS. The electronic device 100 may receive the application execution request based on a user input for executing the application. For example, when the electronic device 100 receives a user input to execute an application, the host application manager 313 of the electronic device 100 may determine whether the application requested to be executed according to the user input is based on the host OS or the guest OS.

In operation 602, according to reception of the guest application execution request, the host application manager 313 may transmit the request to execute the guest application to the guest application manager 323 of the guest system 320.

In operation 603, the guest application manager 323 may control to execute the guest application 321.

In operation 604, the guest application manager 323 may notify the guest window manager 324 that execution of the guest application has started.

In operation 605, the guest window manager 324 may transmit a window creation request for the guest application to the host window manager 314. That is, because the host system has authority for a window drawn on a display screen of the electronic device 100, the guest window manager 324 may transmit the window creation request to the host window manager 314.

In operation 606, the host window manager 314 may allocate a window for the guest application. That is, the host window manager 314 may determine information about a window area on which a result screen displayed according to the execution of the guest application is to be output. The information about the window area for the guest application may include information about a location where the window is to be displayed on the display screen and information about the size of the window.

In operation 607, the host window manager 314 may transmit the information about the window area allocated for the guest application to the guest window manager 324.

In operation 608, the guest window manager 324 may receive a guest application execution screen according to the execution of the guest application.

In operation 609, the guest window manager 324 may generate a guest OS screen by arranging the guest application execution screen on the window area allocated for the guest application received from the ghost window manager 314.

In operation 610, the guest window manager 324 may transmit the guest OS screen to the host window manager 314.

In operation 611, the host window manager 314 may receive a host application execution screen.

In operation 612, the host window manager 314 may generate a host OS screen based on the host application execution screen, and may generate and display a full host OS screen by combining the guest OS screen received from the guest window manager 324 with the host OS screen.

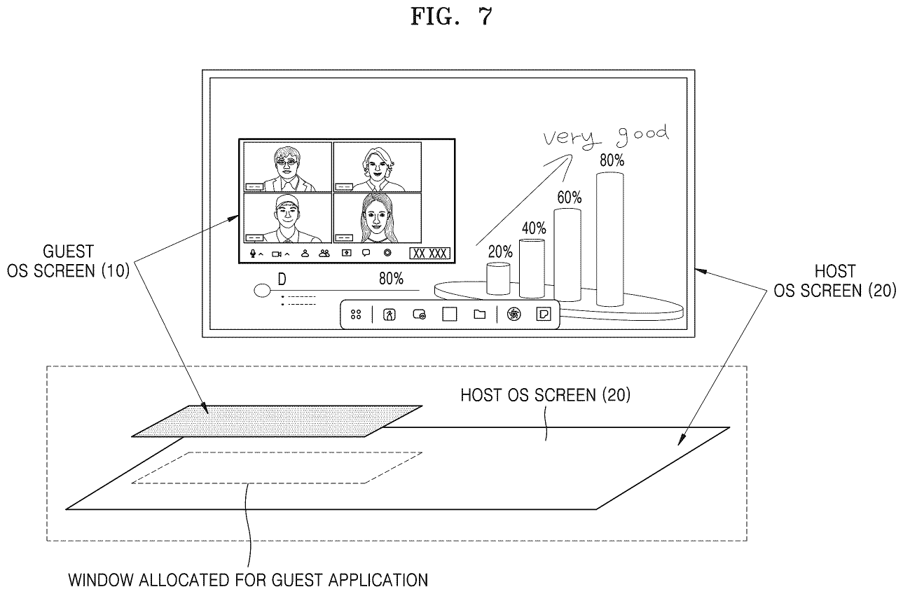

FIG. 7 illustrates an example of a guest OS screen and a host OS screen, according to an embodiment of the disclosure.

Referring to FIG. 7, a host OS screen is a screen obtained by executing a host application and may be generated by a host window manager. A guest OS screen is a screen obtained by executing a guest application and may be generated by a guest window manager.

The host window manager may obtain a full host OS screen by combining the guest OS screen with the host OS screen. That is, because a guest system generates the guest OS screen and provides the guest OS screen to a host system, the guest system may not know the host OS screen. However, because the host system receives the guest OS screen from the guest system and generates a screen finally displayed on a display, the host system may know both the host OS screen and the guest OS screen.

For example, it is assumed that a host OS is a Tizen OS and a guest OS is an Android OS. When a Tizen home application is executed based on the Tizen OS and a video conferencing application is executed based on the Android OS, the host OS screen may be a Tizen home screen, and the guest OS screen may be a video conference screen. The host OS may obtain a full screen by combining the video conference screen with the Tizen home screen and may display the full screen.

The host system may allocate a window area where the guest OS screen is to be displayed, and may arrange the guest OS screen 10 on a part of the host OS screen 20 to display the same on a display of the electronic device 100. Accordingly, for convenience of explanation, a screen managed by the guest system is referred to as the guest OS screen 10, and a screen managed by the host system is referred to as the host OS screen 20 including the guest OS screen 10.

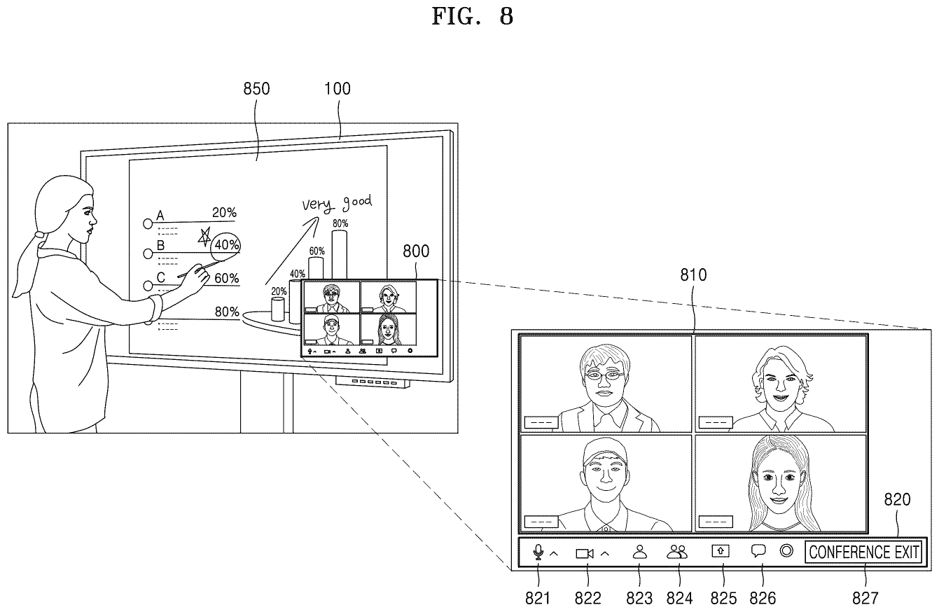

FIG. 8 illustrates an example of a screen on which a video conferencing application is executed as a guest application of a guest system of an electronic device, according to an embodiment of the disclosure.

Referring to FIG. 8, the electronic device 100 may execute a video conferencing application as an example of the guest application 321 of the guest system 320. The electronic device 100 may display a video conference screen 800 according to execution of the video conferencing application. That is, the video conference screen 800 may be an example of the guest OS screen 10. The video conference screen 800 may include a portion 810 on which an image of at least one of a user of the electronic device 100 or a counterpart user participating in a video conference, and a menu window 820 for controlling the video conference. The menu window 820 may include one or more menus for controlling the video conference. The menu window 820 may include, for example, a mute menu 821 that may control muting of the user of the electronic device 100, a video stop menu 822 that may stop a video output of the user of the electronic device 100, an invitation menu 823 that may invite a new user, a participant menu 824 that may manage video conference participants, a screen sharing menu 825 that allows a screen displayed on the electronic device 100 to be shared with other participants, a chat menu 826 that allows chatting with other participants, and a conference exit menu 827 that allows leaving the video conference.

Also, the electronic device 100 may execute, for example, a writing and drawing application as an example of a host application of a host system so that the user performs a function such as writing or drawing on a document 850 displayed on a display screen of the electronic device 100 according to input content using an electronic pen. The user may want to share a host screen according to execution of the host application provided by the host system of the electronic device 100 during the video conference.

When an input that selects the screen sharing menu 825 is received from the user on the video conference screen 800 displayed on the electronic device 100, it may be preferable that the electronic device 100 provides the host screen even though a screen sharing request is received through the guest application.

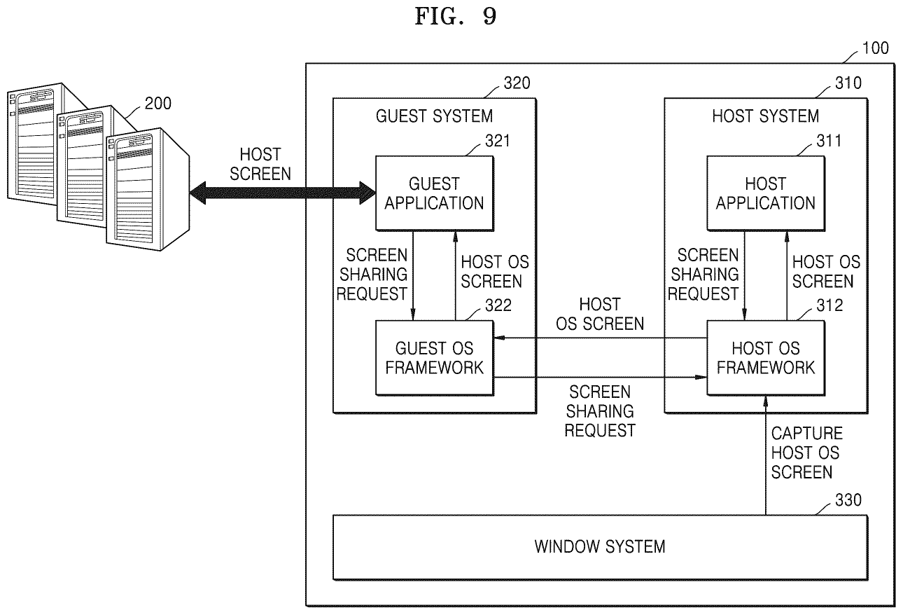

FIG. 9 is a reference diagram for describing an operation of processing a screen sharing request received by a guest application of a guest system of an electronic device, according to an embodiment of the disclosure.

Referring to FIG. 9, when the electronic device 100 receives a screen sharing request through the guest application 321 executed in the guest system 320, the guest application 321 may transmit the screen sharing request to the guest OS framework 322. The guest OS framework 322 may transmit the screen sharing request to the host OS framework 312.

The host OS framework 312 receiving the screen sharing request from the guest OS framework 322 may capture a host OS screen displayed on the electronic device 100 through the window system 330. The host OS framework 312 may transmit the captured host OS screen to the guest OS framework 322. The guest OS framework 322 may transmit the received host OS screen to the guest application 321. The guest application 321 may transmit the received host OS screen to the server 200. As such, because a screen sharing request received by a guest application is not directly processed by the guest application, but a host system is requested and a host OS screen is received, the electronic device 100 may transmit the OS host screen, instead of a guest OS screen, to the server 200. The host OS screen may include the guest OS screen.

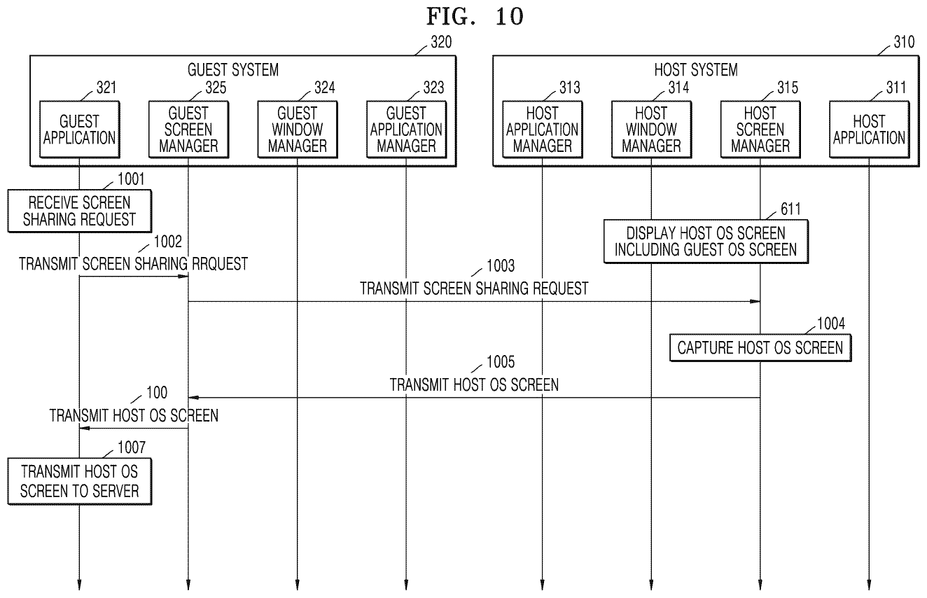

FIG. 10 is an example of a flowchart illustrating an operation of processing a screen sharing request received by a guest application of a guest system of an electronic device, according to an embodiment of the disclosure.

Referring to FIG. 10, in operation 1001, the guest application 321 of the guest system 320 of the electronic device 100 may receive an input that selects a screen sharing request. For example, the electronic device 100 may receive the input that selects the screen sharing request by receiving an input that selects the screen sharing menu 825 on the video conference screen 800 as shown in FIG. 8. For example, when a display of the electronic device 100 is a touch sensitive display, the electronic device 100 may receive the input that selects the screen sharing request according to an input that touches the display. For example, the electronic device 100 may receive the input that selects the screen sharing request by receiving a control signal from an external input device.

In operation 1002, the guest application 321 may transmit the screen sharing request to the guest screen manager 325 according to the input that selects the screen sharing request.

In operation 1003, the guest screen manager 325 may transmit the screen sharing request to the host screen manager 315. Communication between a guest OS and a host OS may be performed in various ways. For example, there is a method of setting a virtual network interface so that the guest OS and the host OS communicate with each other through a network, or setting communication by forwarding a port from the host OS to the guest OS.

In operation 1004, the host screen manager 315 may capture a host OS screen through the window system 330. The host screen manager 315 may periodically capture the host OS screen. The host OS screen captured by the host screen manager 315 through the window system may be a full host OS screen including a guest OS screen.

In operation 1005, the host screen manager 315 may transmit the captured host OS screen to the guest screen manager 325.

In operation 1006, the guest screen manager 325 may transmit the host OS screen to the guest application 321.

In operation 1007, the guest application 321 may transmit the received host OS screen to a server.

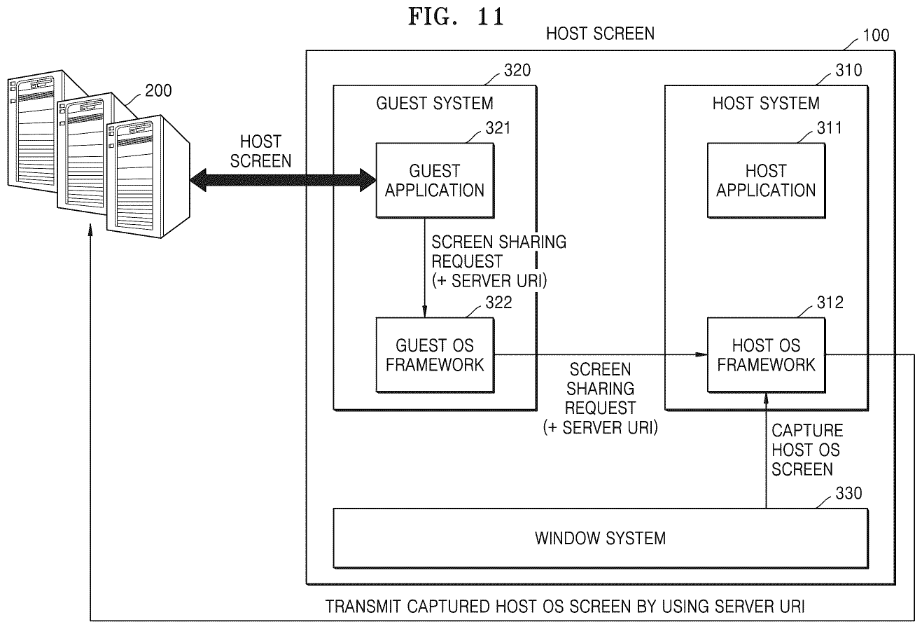

FIG. 11 is a reference diagram for describing an operation of processing a screen sharing request received by a guest application of a guest system of an electronic device, according to an embodiment of the disclosure.

Referring to FIG. 11, when the electronic device 100 receives a screen sharing request through the guest application 321 executed in the guest system 320, the guest application 321 may transmit the screen sharing request to the guest OS framework 322. In this case, the guest application 321 may transmit server identification information together with the screen sharing request. The server identification information is information for identifying a server to which the guest application is to transmit a screen for screen sharing, and may be referred to as server access information or server address information. The server identification information may include, for example, a server uniform resource identifier (URI). The guest OS framework 322 may transmit the server identification information together with the screen sharing request to the host OS framework 312.

The host OS framework 312 receiving the screen sharing request and the server identification information from the guest OS framework 322 may capture a host OS screen displayed on the electronic device 100 through the window system 330. The host OS framework 312 may transmit the captured host OS screen to the server 200 by using the server identification information received from the guest system 320. As such, in the example of FIG. 11, because a screen sharing request received by a guest application is not directly processed by the guest application, but the host system is requested and the host system 310 directly transmits the captured OS screen to the server 200 by using server identification information without passing through the guest system 320, the host OS screen may be provided to the server 200 without further delay.

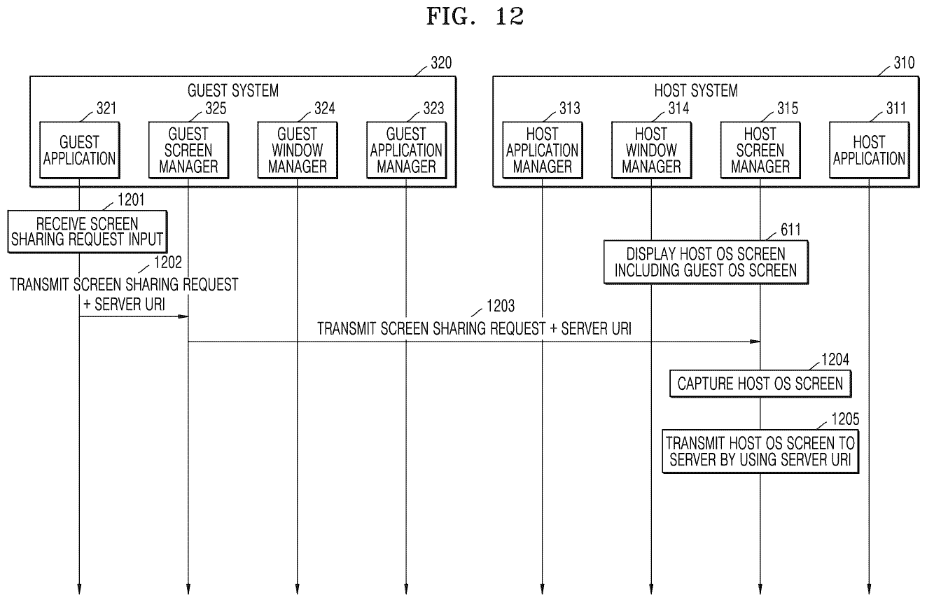

FIG. 12 is an example of a flowchart illustrating an operation of processing a screen sharing request received by a guest application of a guest system of an electronic device, according to an embodiment of the disclosure.

Referring to FIG. 12, in operation 1201, the guest application 321 of the guest system 320 of the electronic device 100 may receive an input that selects a screen sharing request. For example, the electronic device 100 may receive the input that selects the screen sharing request by receiving an input that selects the screen sharing menu 825 on the video conference screen 800 as show in FIG. 8. For example, when a display of the electronic device 100 is a touch sensitive display, the electronic device 100 may receive the input that selects the screen sharing request according to an input that touches the display. For example, the electronic device 100 may receive the input that selects the screen sharing request by receiving a control signal from an external input device.

In operation 1202, the guest application 321 may transmit the screen sharing request to the guest screen manager 325 according to the input that selects the screen sharing request. In this case, the guest application 321 may transmit the screen sharing request together with a server URI as identification information for a server to which a screen to be shared is to be transmitted. The server URI is address information for identifying the server to which the screen to be shared is to be transmitted according to the screen sharing request.

In operation 1203, the guest screen manager 325 may transmit the screen sharing request and the server URI to the host screen manager 315. Communication between a guest OS and a host OS may be performed in various ways. For example, there is a method of setting a virtual network interface so that a guest OS and a host OS communicate with each other through a network, or setting communication by forwarding a port from the host OS to the guest OS.

In operation 1204, the host screen manager 315 may capture a host OS screen through a window system.

In operation 1205, the host screen manager 315 may directly transmit the host OS screen to the server by using the server URI. Because the host screen manager 315 receives the server URI from the guest system, the host screen manager 315 may directly transmit the host OS screen to the server by using the server URI without having to transmit the host OS screen back to the guest system.

According to an embodiment of the disclosure, the electronic device 100 may receive and display the guest OS screen from an external device by using screen mirroring. Screen mirroring is a process of replicating a screen of a device such as a smartphone, a tablet, or a computer onto another electronic device such as a TV or a monitor. The screen mirroring allows a user to view, for example, content being viewed on a small device on a larger screen. Because the screen mirroring allows a screen of an original device to be transmitted to another device in real time, all operations performed on the original device may be immediately displayed on the mirrored device. The screen mirroring may be performed by using wireless communication such as Wi-Fi or Bluetooth or wired communication through an HDMI cable or the like. The external device may execute a guest application based on a guest OS and according to execution of the guest application, may provide the guest OS screen to the electronic device 100. When a screen sharing request input is received through the guest OS screen, only the guest OS screen may be shared or a host OS screen displayed on the electronic device 100 may be shared.

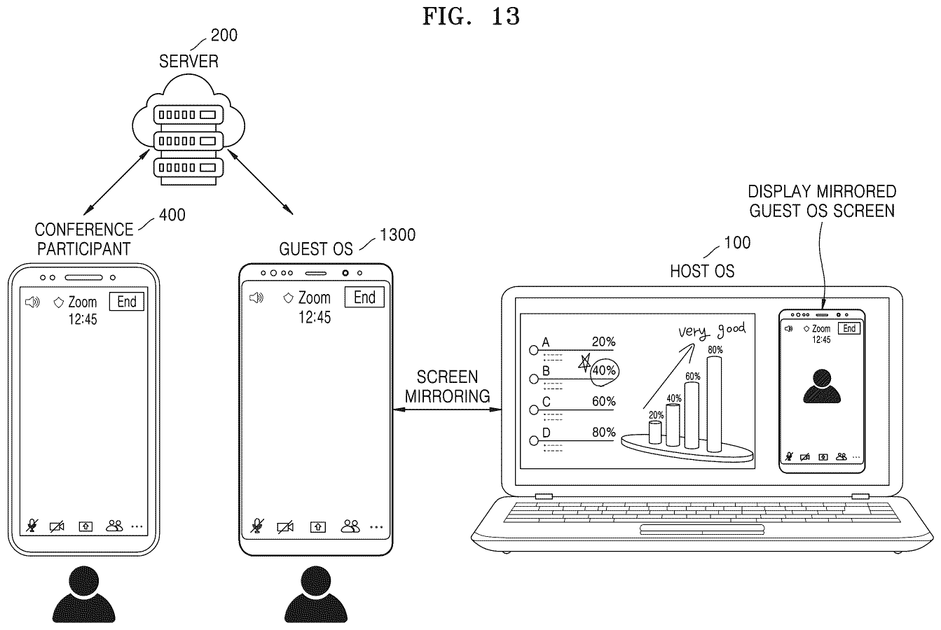

FIG. 13 is a reference diagram for describing an operation in which an electronic device receives a guest OS screen from an external device by using screen mirroring, according to an embodiment of the disclosure.

Referring to FIG. 13, an external device 1300 may execute a guest application based on a guest OS. The guest application may include a video conferencing application or a video call application. For example, when the external device 1300 executes the video conferencing application, the external device 1300 may transmit a voice or an image of a user of the external device 1300 through the server 200, and may receive and output a voice or an image of a user of the counterpart electronic device 400 from the server 200 to perform a video conference or a video call.

Also, the external device 1300 may transmit a guest OS screen of the external device 1300 to the electronic device 100 by using screen mirroring, and the electronic device 100 may display the guest OS screen received by using the screen mirroring from the external device 1300 on a host OS screen based on its host OS.

When a screen sharing function is provided on a menu displayed on the guest OS screen, the user may select a screen sharing function menu on the guest OS screen displayed on the external device 1300, or may select a screen menu sharing menu on the guest OS screen displayed by using the screen mirroring on the electronic device 100.

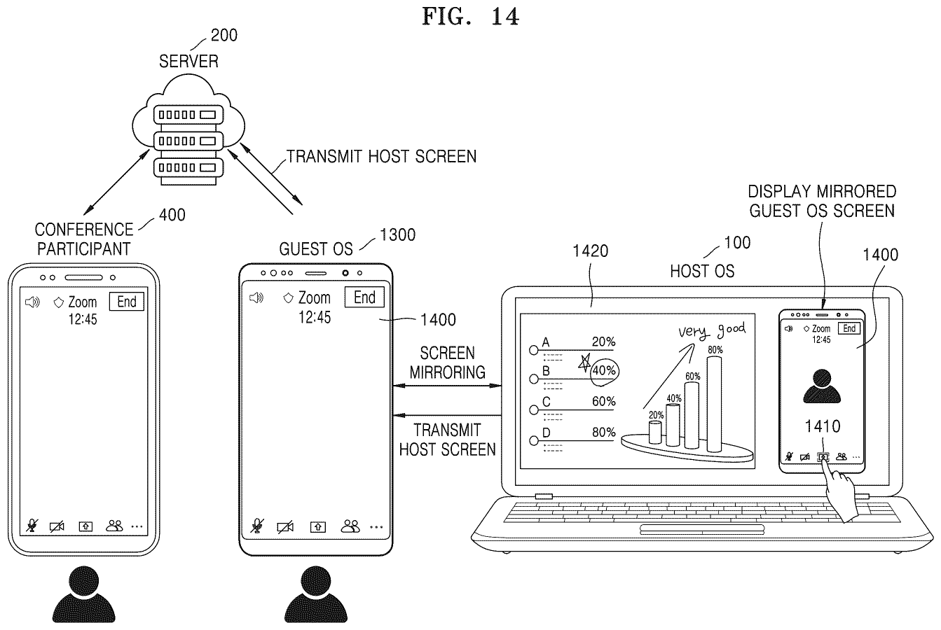

FIG. 14 is a reference diagram for describing an operation when a screen sharing menu is selected on a guest OS screen displayed by using screen mirroring in an electronic device, according to an embodiment of the disclosure.

Referring to FIG. 14, when the electronic device 100 receives an input that selects a screen sharing menu 1410 on a guest OS screen 1400 received from the external device 1300 by using screen mirroring, it may be understood that a user wishes to share a screen displayed on a display of the electronic device 100. The screen displayed on the display of the electronic device 100 may include a full host OS screen including a host OS screen based on a host OS of the electronic device 100 and a guest OS screen received by using the screen mirroring.

In this situation, in order to perform an operation of sharing the full host OS screen displayed on the electronic device 100, the electronic device 100 may first notify the external device 1300 that the screen sharing menu has been selected on the guest OS screen, and the external device 1300 may request the electronic device 100 to share the full host screen of the electronic device 100. the electronic device 100 may transmit the full host screen to the external device 1300 according to a screen sharing request from the external device 1300, or when server URI information is received from the external device 1300, the electronic device 100 may directly transmit the full host screen to a server by using the server URI information.

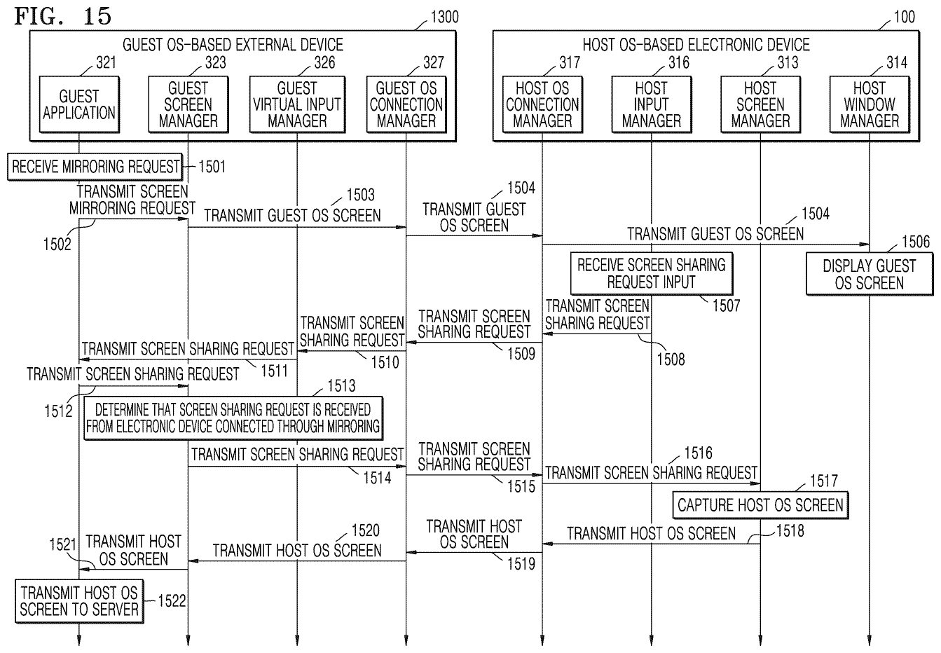

FIG. 15 is an example of a flowchart illustrating an operation when a screen sharing menu is selected on a guest OS screen displayed by using screen mirroring in an electronic device, according to an embodiment of the disclosure.

Referring to FIG. 15, in operation 1501, the guest application 321 of the external device 1300 may receive a screen mirroring request. For example, the external device 1300 may receive the screen mirroring request while displaying a guest OS screen by executing a video conferencing application as an example of a guest application. The screen mirroring request may include a user input that requests screen mirroring.

In operation 1502, the guest application 321 may transmit the screen mirroring request to the guest screen manager 323.

In operation 1503, as the guest screen manager 323 receives the screen mirroring request, the guest screen manager 323 may capture the guest OS screen output to a display of the external device 1300 and may transmit the guest OS screen to a guest OS connection manager 327.

In operation 1504, the guest OS connection manager 327 may transmit the received guest OS screen to a host OS connection manager 317 of the electronic device 100. The guest OS connection manager 327 and the host OS connection manager 317 may control the guest OS screen to be transmitted and received through various wired or wired communication technologies.

In operation 1505, the host OS connection manager 317 may transmit the guest OS screen to the host window manager 314.

The host window manager 314 may control the guest OS screen to be arranged on at least a portion of a host OS screen displayed based on a host OS of the electronic device 100 and displayed on the display.

As such, the electronic device 100 may display the guest OS screen received from the external device 1300 by using the screen mirroring on the host OS screen of the electronic device 100.

In operation 1507, a host input manager 316 of the electronic device 100 may receive a screen sharing request input. For example, as shown in FIG. 14, the electronic device 100 may receive an input that selects the screen sharing menu 1410 provided on the guest OS screen 1400 displayed on the display of the electronic device 100. As such, the input that selects the screen sharing menu 1410 may be received by the host input manager 316. For example, the electronic device 100 may receive the input that selects the screen sharing menu 1410 through a remote controller or a touch input, and the input that selects the screen sharing menu 1410 may be transmitted to the host input manager 316.

In operation 1508, the host input manger 316 may transmit the screen sharing request input to the host OS connection manager 317.

In operation 1509, the host OS connection manager 317 may transmit the screen sharing request input to the guest OS connection manger 327.

In operation 1510, the guest OS connection manager 327 may transmit the screen sharing request input to a guest virtual input manager 326.

In operation 1511, the guest virtual input manger 326 may transmit the screen sharing request input to the guest application 321. The guest virtual input manager 326 may transmit the screen sharing request input to the guest application 321 in the same operation as receiving the screen sharing request input in the external device 1300.

In operation 1512, the guest application 321 may transmit a screen sharing request to the guest screen manager 323 based on the screen sharing request input received from the guest virtual input manger 326.

In operation 1513, the guest screen manger 323 may receive the screen sharing request from the guest application 321, and may determine that the screen sharing request is received from the electronic device connected through mirroring. Because the screen sharing request received by the guest screen manager 323 includes information indicating that the request is input from the electronic device 100, the guest screen manager 323 may determine that the screen sharing request is received from the electronic device. The guest screen manager 323 may determine that the screen sharing request is received from the electronic device by determining that the screen sharing request is received through the guest OS connection manger 327.

In operation 1514, as the guest screen manager 323 determines that the screen sharing request is received from the electronic device connected through the mirroring, the guest screen manager 323 may transmit the screen sharing request to the guest OS connection manager 327 for sharing the host OS screen.

In operation 1515, the guest OS connection manager 327 may transmit the screen sharing request received from the guest screen manager 323 to the host OS connection manager 317.

In operation 1516, the host OS connection manager 317 may transmit the screen sharing request to the host screen manager 313.

In operation 1517, the host screen manager 313 may capture the host OS screen through a window system. For example, the host screen manager 313 may capture a host OS screen 1420 including the guest OS screen 1400.

In operation 1518, the host screen manager 313 may transmit the captured host OS screen to the host OS connection manager 317.

In operation 1519, the host OS connection manager 317 may transmit the host OS screen to the guest OS connection manager 327.

In operation 1520, the guest OS connection manager 327 may transmit the host OS screen to the guest screen manager 323.

In operation 1521, the guest screen manager 323 may transmit the host OS screen to the guest application 321.

In operation 1522, the guest application 321 may transmit the host OS screen to the server 200.

In the example of FIG. 15, an operation of sharing a screen to a server by transmitting a host OS screen captured in a host system of the electronic device 100 to the external device 1300 based on a guest OS for screen sharing has been described. However, the disclosure is not limited to the operation. When the external device 1300 provides a server URI together with a screen sharing request to the electronic device 100, the host screen manager 313 may directly transmit the captured host OS screen to the server by using the server URI received from the external device 1300.

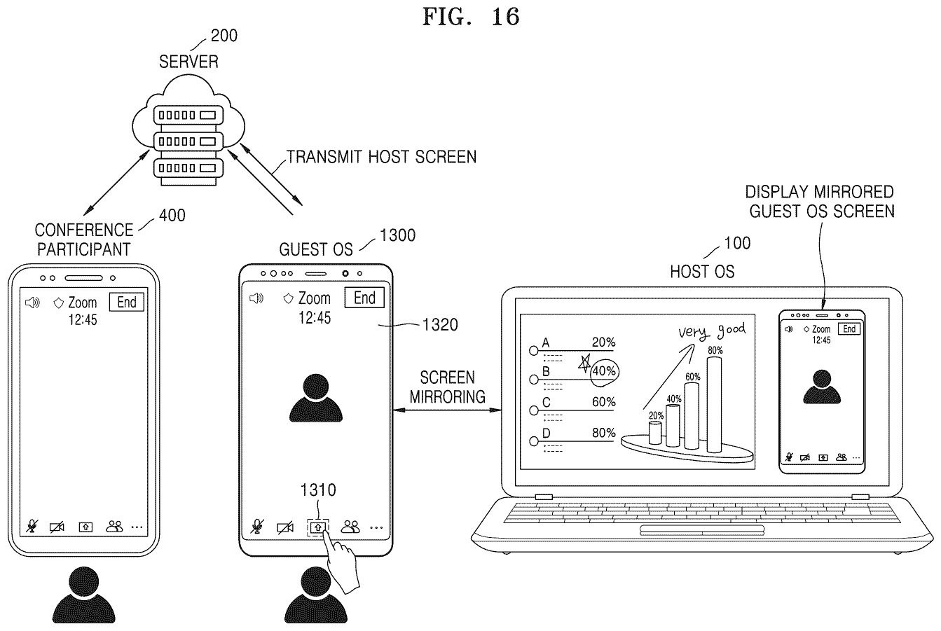

FIG. 16 is a reference diagram for describing an operation when a screen sharing menu is selected in an external device while the external device provides a guest OS screen to an electronic device by using screen mirroring, according to an embodiment of the disclosure.

Referring to FIG. 16, while the external device 1300 transmits a guest OS screen to the external device 1300 by using screen mirroring and the guest OS screen is displayed on the electronic device 100, when an input that selects a screen sharing menu provided on the guest OS screen displayed on the external device 1300 is received, it may be understood that a user wishes to share a screen displayed on a display of the external device 1300. In this situation, because the screen that the user wants to share seems to have little relevance to a host OS screen, the external device 1300 may perform an operation of sharing the guest OS screen displayed on its display.

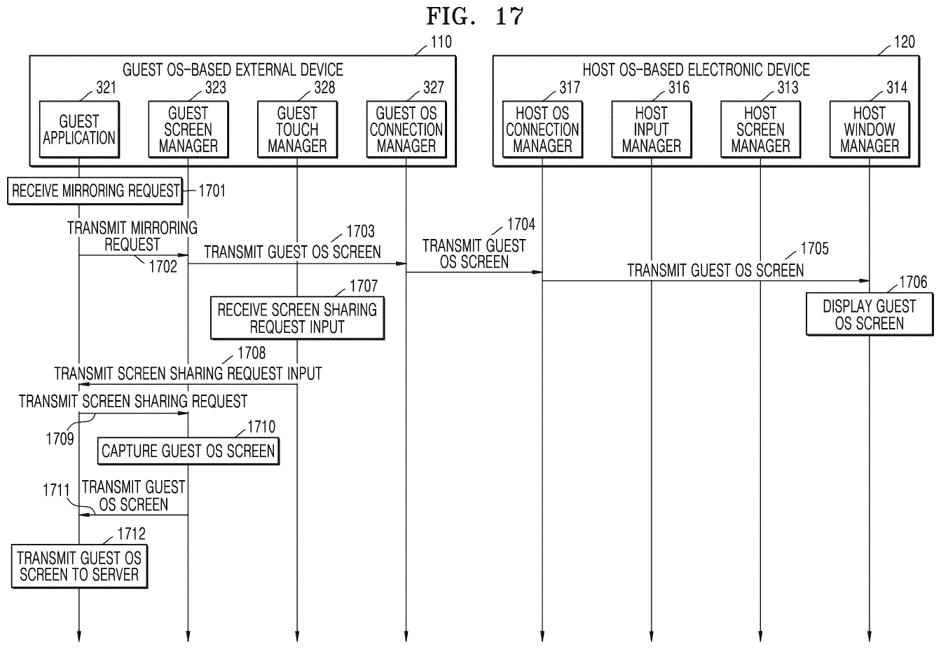

FIG. 17 is an example of a flowchart illustrating an operation when a screen sharing menu is selected on a guest OS screen displayed by using screen mirroring in an electronic device, according to an embodiment of the disclosure.

Referring to FIG. 17, operations 1701 to 1706 relate to an operation of displaying a guest OS screen on a display of the electronic device 100 by using screen mirroring and are the same as operations 1501 to 1506 of FIG. 15, and thus, reference may be made to the descriptions of FIG. 15 for additional implementation details.

While the electronic device 100 displays a guest OS screen received from the external device 1300 by using screen mirroring on a host OS screen of the electronic device 100, in operation 1707, a guest touch manager 328 of the external device 1300 may receive a screen sharing request input. For example, in a situation as shown in FIG. 16, the external device 1300 may receive an input that selects a screen sharing menu 1310 provided on a guest OS screen 1320 displayed on a display of the external device 1300. As such, the input that selects the screen sharing menu 1310 may be received by the guest touch manager 328.

In operation 1708, the guest touch manager 328 may transmit the screen sharing request input to the guest application 321.

In operation 1709, the guest application 321 may transmit a screen sharing request to the guest screen manager 323 based on the screen sharing request input received from the guest touch manager 328.

In operation 1710, the guest screen manager 323 may receive the screen sharing request from the guest application 321 and may capture the guest OS screen.

In operation 1711, the guest screen manager 323 may transmit the guest OS screen to the guest application 321.

In operation 1712, the guest application 321 may transmit the guest OS screen to a server.

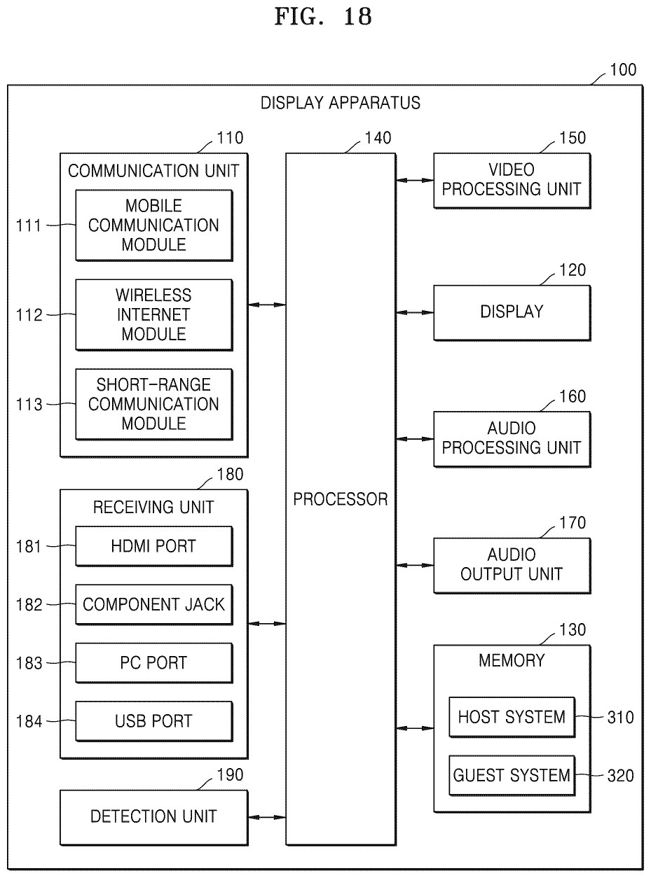

FIG. 18 is an example of a detailed block diagram illustrating an electronic device, according to an embodiment of the disclosure.

Referring to FIG. 18, the electronic device 100 may further include a video processing unit 150, an audio processing unit 160, an audio output unit 170, a receiving unit 180, and a detection unit 190, in addition to the communication unit 110, the display 120, the memory 130, and the processor 140.

The communication unit 110 may include various communication circuits included in one or more modules that enable wireless communication between the electronic device 100 and a wireless communication system or between the electronic device 100 and a network in which another electronic device is located. For example, the communication unit 110 may include a mobile communication module 111, a wireless Internet module 112, and a short-range communication module 113.

The mobile communication module 111 transmits and receives a wireless signal to and from at least one of a base station, an external terminal, or a server, on a mobile communication network. The wireless signal may include a voice call signal, a video call signal, or various types of data according to text/multimedia message transmission/reception.

The wireless Internet module 112 refers to a module for wireless Internet access, and may be internally or externally coupled to a device. Examples of wireless Internet technology may include wireless local area network (WLAN) (Wi-Fi), wireless broadband (Wibro), world interoperability for microwave access (Wimax), and high speed downlink packet access (HSDPA). Through the wireless Internet module 112, the device may establish a Wi-Fi peer to peer (P2P) connection with other devices.

The short-range communication module 113 refers to a module for short-range communication. Examples of short-range communication technology may include Bluetooth, Bluetooth low energy (BLE), radio frequency identification (RFID), infrared data association (IrDA), ultra-wideband (UWB), and Zigbee.

The display 120 may display the image signal received from the video processing unit 150 on a screen.

The memory 130 may store a program related to an operation of the electronic device 100 and various data generated during the operation of the electronic device 100. The memory 130 may include the host system 310 and the guest system 320 as shown in FIG. 3.

The video processing unit 150 may process an image signal received from the receiving unit 180 or the communication unit 110 and may output the image signal to the display 120 under the control of the processor 140.

The audio processing unit 160 may convert an audio signal received from the receiving unit 180 or the communication unit 110 into an analog audio signal and may output the analog audio signal to the audio output unit 170 under the control of the processor 140.

The audio output unit 170 may output the received analog audio signal through a speaker.

The receiving unit 180 may receive a video (e.g., a moving image), an audio (e.g., voice or music), and additional information (e.g., EPG) from the outside of the electronic device 100 under the control of the processor 140. The receiving unit 180 may include one of a high-definition multimedia interface (HDMI) port 181, a component jack 182, a PC port 183, and a universal serial bus (USB) port 184, or a combination thereof. The receiving unit 180 may further include a display port (DP), a thunderbolt, and a mobile high-definition link (MHL) in addition to the HDMI port.

The detection unit 190 may detect a user's voice, image, or interaction, and may include a microphone, a camera unit, and a light receiving unit. The microphone receives a voice uttered by the user. The microphone may convert the received voice into an electrical signal and may output the electrical signal to the processor 140. The camera unit may receive an image (e.g., consecutive frames) corresponding to a motion of the user including a gesture within a camera recognition range. The light receiving unit receives an optical signal (including a control signal) received from a remote controller. The light receiving unit may receive an optical signal corresponding to a user input (e.g., a touch, a press, a touch gesture, a voice, or a motion) from the remote controller.

The electronic device according to an embodiment of the disclosure may include a memory in which one or more instructions are stored and at least one processor configured to execute the one or more instructions.

According to an embodiment of the disclosure, when the one or more instructions are executed by the at least one processor individually and/or collectively, the electronic device may display, according to execution of a guest application based on a guest OS, a guest OS screen corresponding to the guest application on at least a part of a host OS screen based on a host OS.

According to an embodiment of the disclosure, when the one or more instructions are executed by the at least one processor individually and/or collectively, the electronic device may receive a screen sharing request through the guest application.

According to an embodiment of the disclosure, when the one or more instructions are executed by the at least one processor individually and/or collectively, the electronic device may transmit the host OS screen including the guest OS screen to a server for screen sharing according to the screen sharing request.

According to an embodiment of the disclosure, when the one or more instructions are executed by the at least one processor individually and/or collectively, the electronic device may transmit, according to the screen sharing request, by the guest OS, the screen sharing request to the host OS.

According to an embodiment of the disclosure, when the one or more instructions are executed by the at least one processor individually and/or collectively, the electronic device may capture, by the host OS, according to the screen sharing request from the guest OS, the host OS screen including the guest OS screen, and may transmit the host OS screen including the guest OS screen to the guest OS.

According to an embodiment of the disclosure, when the one or more instructions are executed by the at least one processor individually and/or collectively, the electronic device may transmit, by the guest application, the host OS screen including the guest OS screen to the server.

According to an embodiment of the disclosure, when the one or more instructions are executed by the at least one processor individually and/or collectively, the electronic device may transmit, according to the screen sharing request, by the guest OS, the screen sharing request together with server identification information for identifying the server to the host OS.

According to an embodiment of the disclosure, when the one or more instructions are executed by the at least one processor individually and/or collectively, the electronic device may transmit, by the host OS, according to the screen sharing request from the guest OS, the host OS screen including the guest OS screen to the server by using the server identification information.

According to an embodiment of the disclosure, when the one or more instructions are executed by the at least one processor individually and/or collectively, the electronic device may designate, according to execution of the guest application, by the host OS, a window for the guest application, and may display the guest OS screen on the designated window.

According to an embodiment of the disclosure, when the one or more instructions are executed by the at least one processor individually and/or collectively, the electronic device may receive and display the guest OS screen corresponding to the guest application executed in an external device through screen mirroring.

According to an embodiment of the disclosure, when the one or more instructions are executed by the at least one processor individually and/or collectively, the electronic device may transmit, according to the screen sharing request through the guest OS screen displayed based on the screen mirroring in the electronic device, the host OS screen including the guest OS screen to the server.

According to an embodiment of the disclosure, when the one or more instructions are executed by the at least one processor individually and/or collectively, the electronic device may receive a screen sharing input through the guest OS screen displayed based on the screen mirroring.

According to an embodiment of the disclosure, when the one or more instructions are executed by the at least one processor individually and/or collectively, the electronic device may receive, according to transmission of the screen sharing input to the external device, a screen sharing request of the host OS screen from the external device.

According to an embodiment of the disclosure, when the one or more instructions are executed by the at least one processor individually and/or collectively, the electronic device may capture and output, according to the screen sharing request of the host OS screen, the host OS screen including the guest OS screen.

According to an embodiment of the disclosure, when the one or more instructions are executed by the at least one processor individually and/or collectively, the electronic device may transmit the host OS screen including the guest OS screen to the external device or may directly transmit the host OS screen including the guest OS screen to the server by using server identification information.

According to an embodiment of the disclosure, a method of operating an electronic device may include displaying, on at least a part of a host OS screen of a host OS, a guest OS screen corresponding to a guest application being executed on the guest OS; receiving a screen sharing request through the guest application.

According to an embodiment of the disclosure, the method of operating the electronic device may include receiving a screen sharing request through the guest application.

According to an embodiment of the disclosure, the method of operating the electronic device may include capturing a screen of the host OS including the guest OS screen, and transmitting the captured screen to a server for screen sharing based on the screen sharing request.

According to an embodiment of the disclosure, the method of operating the electronic device may include transmitting the screen sharing request to the host OS via the guest OS.

According to an embodiment of the disclosure, the method of operating the electronic device may include, based on the screen sharing request being received by the host OS, capturing, by the host OS, the screen of the host OS including the guest OS screen, and transmitting the captured screen to the guest OS.

According to an embodiment of the disclosure, the method of operating the electronic device may include transmitting the captured screen to the server via the guest application.

According to an embodiment of the disclosure, the method of operating the electronic device may include transmitting to the host OS, by the guest OS, the screen sharing request and server identification information for the server.

According to an embodiment of the disclosure, the method of operating the electronic device may include, based on the screen sharing request being received by the host OS, transmitting the captured screen to the server, via the host OS, using the server identification information.

According to an embodiment of the disclosure, the method of operating the electronic device may include, based on the guest application being executed, designating a window of the host OS for the guest application, and displaying the guest OS screen on the designated window.

According to an embodiment of the disclosure, the guest application may be executed via an external device, and the method of operating the electronic device may include receiving the guest OS screen may include receiving the guest OS screen through screen mirroring.

According to an embodiment of the disclosure, the method of operating the electronic device may include transmitting the captured screen to the server based on the guest OS screen being received through the screen mirroring.

According to an embodiment of the disclosure, the method of operating the electronic device may include receiving a screen sharing input through the guest OS and transmitting the screen sharing input to the external device.

According to an embodiment of the disclosure, the method of operating the electronic device may include receiving the screen sharing request from the external device through the guest application.

According to an embodiment of the disclosure, the method of operating the electronic device may include, based on the screen sharing request being received by the host OS, capturing and outputting the screen of the host OS including the guest OS screen.

According to an embodiment of the disclosure, the method of operating the electronic device may include transmitting the captured screen to the server may include transmitting the captured screen to the server via the external device; or directly transmitting the captured screen from the host OS to the server by using server identification information for the server.

According to an embodiment of the disclosure, the host OS and the guest OS may communicate through at least one of a virtual network interface or by forwarding a port from the host OS to the guest OS.

Some embodiments of the disclosure may be implemented in the form of a computer-readable recording medium that includes computer-executable instructions such as program modules executed by a computer. The computer-readable medium may be an arbitrary available medium accessible by a computer, and includes all volatile and non-volatile media and separable and non-separable media. The computer-readable medium may also include a computer storage medium. Examples of the computer storage medium include all volatile and non-volatile media and separable and non-separable media, which have been implemented by an arbitrary method or technology, for storing information such as computer-readable instructions, data structures, program modules, and other data.

Embodiments of the disclosure may be implemented as a software program including instructions stored in a computer-readable storage medium.

The computer is a device capable of fetching instructions stored in a storage medium and operating according to embodiments of the disclosure based on the instructions, and may include an electronic device according to embodiments of the disclosure.

The computer-readable storage medium may be provided in the form of a non-transitory storage medium. The term ‘non-transitory’ only means that the storage medium is tangible without including a signal, but does not distinguish any data stored semi-permanently or temporarily in the storage medium.

Furthermore, control methods according to embodiments of the disclosure may be included and provided in a computer program product. The computer program product may be a product purchasable between a seller and a purchaser.

The computer program product may include a software program and a computer-readable storage medium in which the software program is stored. For example, the computer program product may include a product in the form of a software program (e.g., a downloadable application) that is electronically distributed by a manufacturer of a device or by an electronic market (e.g., Google play store™ or App store™). For electronic distribution, at least a portion of the software program may be stored in a storage medium or temporarily generated. In this case, the storage medium may be a storage medium of a server of the manufacturer, a server of the electronic market, or a relay server that temporarily stores the software program.

In a system including a server and a device, the computer program product may include a storage medium of the server or a storage medium of the device. When there is a third device (e.g., a smartphone) communicatively connected to the server or the device, the computer program product may include a storage medium of the third device. The computer program product may include a software program itself that is transmitted from the third device to the device, or transmitted from the server to the device or the third device.

In this case, one of the server, the device, and the third device may execute the computer program product to perform a method according to embodiments of the disclosure. Two or more of the server, the device, and the third device may execute the computer program product to perform the method according to embodiments of the disclosure in a distributed fashion.

For example, the server (e.g., a cloud server or an artificial intelligence (AI) server) may execute the computer program product stored therein to control the device communicatively connected to the server to perform the method according to embodiments of the disclosure.

In yet another example, the third device may execute the computer program product to control the device communicatively connected to the third device to perform the method according to embodiments of the disclosure. When the third device executes the computer program product, the third device may download the computer program product from the server and execute the downloaded computer program product. The third device may execute the computer program product that is preloaded to perform the method according to embodiments of the disclosure.

Also, the term “unit” used herein may be a hardware component such as a processor or a circuit, and/or a software component executed by a hardware component such as a processor.

The above description of the disclosure is provided for illustration, and it will be understood by one of ordinary skill in the art that various changes in form and details may be readily made therein without departing from essential features and the scope of the disclosure as defined by the following claims. Accordingly, the above embodiments are examples only in all aspects and are not limited. For example, each component described as a single type may be implemented in a distributed manner, and similarly, components described as distributed may be implemented in a combined form.

The scope of the disclosure is defined by the appended claims rather than the detailed description, and all changes or modifications within the scope of the appended claims and their equivalents will be construed as being included in the scope of the disclosure.

What is claimed is:

1. An electronic device comprising:
memory storing one or more instructions; and
at least one processor
wherein the one or more instructions, when executed by the at least one processor individually or collectively, cause the electronic device to:
display, on at least a part of a host operating system (OS) screen of a host OS, a guest OS screen corresponding to a guest application being executed on a guest OS,
receive a screen sharing request through the guest application, and
capture a screen of the host OS comprising the guest OS screen, and transmit the captured screen to a server for screen sharing based on the screen sharing request.

2. The electronic device of claim 1, wherein the one or more instructions, when executed by the at least one processor individually or collectively, cause the electronic device to:
transmit the screen sharing request to the host OS via the guest OS,
based on the screen sharing request being received by the host OS, capture, by the host OS, the screen of the host OS comprising the guest OS screen, and transmit the captured screen to the guest OS, and
transmit the captured screen to the server via the guest application.

3. The electronic device of claim 1, wherein the one or more instructions, when executed by the at least one processor individually or collectively, cause the electronic device to:
transmit to the host OS, by the guest OS, the screen sharing request and server identification information for the server, and
based on the screen sharing request being received by the host OS, transmit the captured screen to the server, via the host OS, using the server identification information.

4. The electronic device of claim 1, wherein the one or more instructions, when executed by the at least one processor individually or collectively, cause the electronic device to:
based on the guest application being executed, designate a window of the host OS for the guest application, and display the guest OS screen on the designated window.

5. The electronic device of claim 1, wherein the guest application is executed via an external device, and
wherein the one or more instructions, when executed by the at least one processor individually or collectively, cause the electronic device to receive the guest OS screen corresponding to the guest application from the external device through screen mirroring and display the guest OS screen.

6. The electronic device of claim 5, wherein the one or more instructions, when executed by the at least one processor individually or collectively, cause the electronic device to, based on the screen sharing request through the guest OS screen displayed through the screen mirroring, transmit the captured screen to the server.

7. The electronic device of claim 6, wherein the one or more instructions, when executed by the at least one processor individually or collectively, cause the electronic device to:
receive a screen sharing input through the guest OS screen displayed based on the screen mirroring,
transmit the screen sharing input to the external device,
receive the screen sharing request from the external device through the guest application, and
based on the screen sharing request being received by the host OS, capture and output the screen of the host OS comprising the guest OS screen.

8. The electronic device of claim 6, wherein the one or more instructions, when executed by the at least one processor individually or collectively, cause the electronic device to:
transmit the captured screen to the external device, or
transmit the captured screen to the server using server identification information for the server.

9. The electronic device of claim 1, wherein the host OS and the guest OS are configured to communicate through at least one of a virtual network interface or by forwarding a port from the host OS to the guest OS.

10. The electronic device of claim 3, wherein the server identification information comprises a Uniform Resource Identifier (URI) of the server.

11. A method of operating an electronic device, the method comprising:
displaying, on at least a part of a host operating system (OS) screen of a host OS, a guest OS screen corresponding to a guest application being executed on a guest OS;
receiving a screen sharing request through the guest application; and
capturing a screen of the host OS comprising the guest OS screen, and transmitting the captured screen to a server for screen sharing based on the screen sharing request.

12. The method of claim 9, wherein the capturing the screen of the host OS and transmitting the captured screen comprises:
transmitting the screen sharing request to the host OS via the guest OS;
based on the screen sharing request being received by the host OS, capturing, by the host OS, the screen of the host OS comprising the guest OS screen, and transmitting the captured screen to the guest OS; and
transmitting the captured screen to the server via the guest application.

13. The method of claim 11, wherein the capturing the screen of the host OS and transmitting the captured screen comprises:
transmitting to the host OS, by the guest OS, the screen sharing request and server identification information for the server; and
based on the screen sharing request being received by the host OS, transmitting the captured screen to the server, via the host OS, using the server identification information.

14. The method of claim 11, wherein the displaying the guest OS screen comprises, based on the guest application being executed, designating a window of the host OS for the guest application, and displaying the guest OS screen on the designated window.

15. The method claim 11, wherein the guest application is executed via an external device, and
wherein the receiving the guest OS screen comprises receiving the guest OS screen corresponding to the guest application from the external device through screen mirroring and display the guest OS screen through screen mirroring.

16. The method of claim 15, wherein the transmitting the captured screen to the server comprises based on the screen sharing request through the guest OS screen displayed through the screen mirroring, transmitting the captured screen to the server.

17. The method of claim 16, further comprising:
receiving a screen sharing input through the guest OS screen displayed based on the screen mirroring; and
transmitting the screen sharing input to the external device,
wherein the receiving the screen sharing request comprises receiving the screen sharing request from the external device through the guest application, and
wherein the capturing the screen of the host OS comprises, based on the screen sharing request being received by the host OS, capturing and outputting the screen of the host OS comprising the guest OS screen.

18. The method of claim 17, wherein the transmitting the captured screen to the server comprises:
transmitting the captured screen to the external device; or
transmitting the captured screen to the server by using server identification information for the server.

19. The method of claim 11, wherein the host OS and the guest OS communicate through at least one of a virtual network interface or by forwarding a port from the host OS to the guest OS.

20. A non-transitory computer-readable recording medium storing one or more instructions, wherein the one or more instructions, when executed by at least one processor of an electronic device, individually or collectively, cause the electronic device to:
display, on at least a part of a host operating system (OS) screen of a host OS, a guest OS screen corresponding to a guest application being executed on a guest OS;
receive a screen sharing request through the guest application; and
capture a screen of the host OS comprising the guest OS screen, and transmit the captured screen to a server for screen sharing based on the screen sharing request.
